(19) United States
(12) Patent Application Publication
(10) Pub. No.: US 2025/0267608 A1
(43) Pub. Date: Aug. 21, 2025

(54) INFORMATION PROCESSING DEVICE, INFORMATION PROCESSING METHOD, TERMINAL DEVICE, AND SYSTEM

(71) Applicant: Sony Group Corporation, Tokyo (JP)

(72) Inventor: Hiroaki TAKANO, Tokyo (JP)

(73) Assignee: Sony Group Corporation, Tokyo (JP)

(21) Appl. No.: 18/858,348

(22) PCT Filed: Apr. 19, 2023
(86) PCT No.: PCT/JP2023/015549

§ 371 Date: Oct. 21, 2024

(30) Foreign Application Priority Data
Apr. 28, 2022 (JP) 2022-075413

(51) Int. Cl. H04W 60/00; H04W 24/08

(52) U.S. Cl. CPC H04W 60/00; H04W 24/08

(57) ABSTRACT

An information processing device of the present disclosure includes a control unit. The control unit acquires first information regarding a terminal device from a core network (CN) via a service based interface (SBI). The control unit acquires second information including at least one of measurement information measured based on the first information or terminal-related information acquired from the terminal device directly or via the SBI. The control unit specifies the terminal device from the second information or by associating the first information and the second information with each other. The control unit notifies a client device of at least one of the first information or the second information in association with the specified terminal device.

### TECHNICAL FIELD

The present disclosure relates to an information processing device, an information processing method, a terminal device, and a system.

### BACKGROUND ART

In recent years, in cellular wireless communication, a new technology has been introduced in order to cope with diversification of communication services. For example, a technology in which a mobile network discloses a status of communication with a terminal to an application function (AF) of a third party so that the AF establishes a protocol data unit (PDU) session according to network capability has been known.

In addition, a technology in which a terminal device (user equipment (UE)) determines whether or not to transmit PDU-session-related signaling based on area-restriction-related information has been known.

### CITATION LIST

### Patent Literature

PTL 1: JP 2021-513269 T
PTL 2: JP 2021-532675 T

### SUMMARY OF INVENTION

### Technical Problem

In the above-described technology, the AF acquires data from each network function (NF) of the mobile network. However, it is difficult to say that the AF can sufficiently acquire data regarding the terminal device.

For example, in a case where the terminal device is an Internet of Things (IoT) terminal, a client (an example of the AF) that performs communication with the terminal device can more appropriately communicate with the terminal device by using the data regarding the terminal device. As described above, it is desirable that the client more appropriately communicate with the terminal device by acquiring the data regarding the terminal device.

Therefore, the present disclosure provides a mechanism capable of more appropriately communicating with a terminal device.

It should be noted that the above-mentioned problem or purpose is only one of a plurality of problems or purposes that can be solved or achieved by a plurality of embodiments disclosed in the present specification.

### Solution to Problem

An information processing device of the present disclosure includes a control unit. The control unit acquires first information regarding a terminal device from a core network via a service based interface (SBI). The control unit acquires second information including at least one of measurement information measured based on the first information or terminal-related information acquired from the terminal device directly or via the SBI. The control unit specifies the terminal device from the second information or by associating the first information and the second information with each other. The control unit notifies a client device of at least one of the first information or the second information in association with the specified terminal device.

### BRIEF DESCRIPTION OF DRAWINGS

FIG. 1 is a diagram for describing an outline of an information processing system according to an embodiment of the present disclosure.

FIG. 2 is a diagram illustrating an example of a configuration of an information processing device according to an embodiment of the present disclosure.

FIG. 3 is a diagram illustrating an example of a configuration of a base station according to an embodiment of the present disclosure.

FIG. 4 is a diagram illustrating an example of a configuration of a terminal device according to an embodiment of the present disclosure.

FIG. 5 is a diagram illustrating an example of a 5G architecture.

FIG. 6 is a diagram for describing an example of a configuration of a private 5G network according to an embodiment of the present disclosure.

FIG. 7 is a diagram for describing an application programming interface (API) according to an embodiment of the present disclosure.

FIG. 8 is a diagram illustrating an example of the information processing system according to an embodiment of the present disclosure.

FIG. 9 is a sequence diagram illustrating an example of setting of an idle transition time by the base station.

FIG. 10 is a sequence diagram illustrating an example of a flow of first information processing according to a first embodiment of the present disclosure.

FIG. 11 is a flowchart illustrating an example of a flow of confirmation processing according to the first embodiment of the present disclosure.

FIG. 12 is a diagram for describing an example of scheduling of a user equipment (UE) status by a reachability management network function (RAMNF) according to the first embodiment of the present disclosure.

FIG. 13 is a diagram illustrating an example of an information processing system according to a second embodiment of the present disclosure.

FIG. 14 is a sequence diagram illustrating an example of a flow of registration schedule information provision processing according to the second embodiment of the present disclosure.

FIG. 15 is a diagram illustrating an example of a registration schedule according to the second embodiment of the present disclosure.

FIG. 16 is a diagram illustrating an example of a schedule regarding registration according to the second embodiment of the present disclosure.

FIG. 17 is a sequence diagram illustrating an example of a flow of power information provision processing according to the second embodiment of the present disclosure.

FIG. 18 is a diagram illustrating an example of a connection schedule according to the second embodiment of the present disclosure.

FIG. 19 is a table illustrating power information according to the second embodiment of the present disclosure.

FIG. 20 is a table illustrating an example of terminal location information according to the second embodiment of the present disclosure.

FIG. 21 is a sequence diagram illustrating an example of a flow of current terminal location information provision processing according to the second embodiment of the present disclosure.

FIG. 22 is a sequence diagram illustrating an example of a flow of past terminal location information provision processing according to the second embodiment of the present disclosure.

FIG. 23 is a sequence diagram illustrating an example of a flow of future terminal location information provision processing according to the second embodiment of the present disclosure.

FIG. 24 is a diagram for describing an example of integration of information by a RAMNF according to the second embodiment of the present disclosure.

FIG. 25 is a sequence diagram illustrating an example of a flow of provision processing according to a registration condition according to a third embodiment of the present disclosure.

FIG. 26 is a table illustrating an example of group information according to the third embodiment of the present disclosure.

FIG. 27 is a sequence diagram illustrating another example of the flow of the provision processing according to the registration condition according to the third embodiment of the present disclosure.

FIG. 28 is a sequence diagram illustrating an example of a flow of provision processing according to a location condition according to the third embodiment of the present disclosure.

FIG. 29 is a sequence diagram illustrating an example of a flow of provision processing according to a power condition according to the third embodiment of the present disclosure.

FIG. 30 is a diagram illustrating an example of an information processing system according to a first application example of the present disclosure.

FIG. 31 is a diagram illustrating an example of an information processing system according to a second application example of the present disclosure.

### DESCRIPTION OF EMBODIMENTS

Hereinafter, embodiments of the present disclosure will be described in detail with reference to the appended drawings. Note that, in the present specification and the drawings, components having substantially the same functional configuration are provided with the same reference signs, so that an overlapping description of these components is omitted.

In addition, in the present specification and drawings, similar components of embodiments may be distinguished by adding different alphabets or numerals after the same reference sign. However, in a case where it is not necessary to particularly distinguish each of similar components, only the same reference sign is assigned. Each of one or more embodiments (including examples, modified examples, and application examples) described below can be implemented independently. On the other hand, at least some of the plurality of embodiments described below may be implemented in combination with at least some of other embodiments as appropriate. These plurality of embodiments may include novel characteristics different from each other. Therefore, these plurality of embodiments can contribute to achieve or solving different purposes or problems, and can exert different effects.

### 1. Introduction

### 1.1. Problem

In recent years, a technology related to a service using a 5G network has attracted attention. The 5G network and the service using the 5G network basically operate independently. Therefore, it is hard to say that a service side sufficiently uses information of a network side.

The service side can obtain some pieces of information of the network side by using a 5G application programming interface (API), but it cannot be said that sufficient information has been obtained. In addition, it cannot be said that the service side has sufficiently notified the network side of a request for information desired to be acquired.

For example, the service side can more appropriately perform communication with a terminal device by acquiring information regarding the terminal device that performs communication via the network. For example, the service side can select a terminal device corresponding to a service, such as a terminal device whose remaining power is equal to or more than a predetermined value or a terminal device located in a specific area, to perform communication by acquiring a power status and more detailed location information of the terminal device.

In this manner, a mechanism capable of more appropriately performing communication with the terminal device on the service side is required.

### 1.2. Overview of Proposed Technology

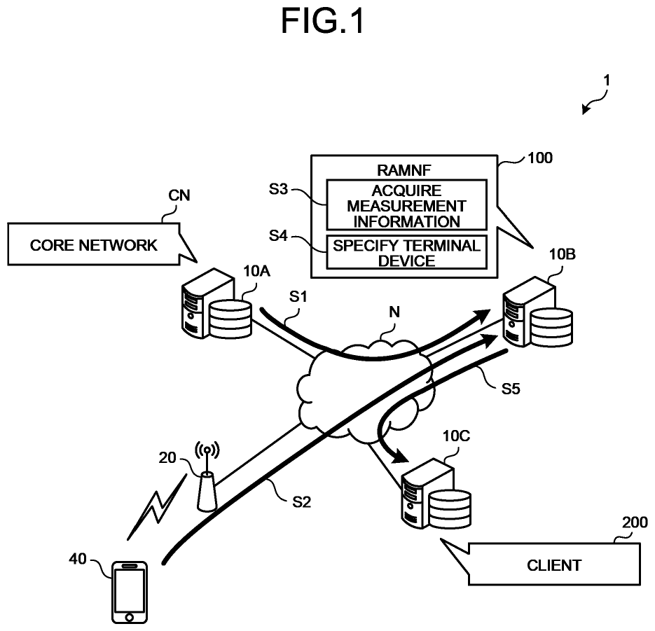

FIG. 1 is a diagram for describing an outline of an information processing system 1 according to an embodiment of the present disclosure. The information processing system 1 illustrated in FIG. 1 includes information processing devices 10A to 10C, a base station 20, and a terminal device 40.

The information processing device 10A is, for example, a server device that implements a function of a core network CN (an example of a network). Here, one information processing device 10A implements the function of the core network CN, but a plurality of information processing devices 10 may implement the function of the core network CN in cooperation with each other.

The information processing device 10B is, for example, a server device that implements a function of a reachability management network function (RAMNF) 100. The RAMNF 100 is a platform that notifies a service-side client 200 of information of the core network CN. Note that FIG. 1 illustrates a case where the RAMNF 100 is an NF (AF) different from the core network CN, but the RAMNF 100 may be implemented as an NF in the core network CN.

The information processing device 10C is, for example, a server device (client device) that implements the function of the server-side client 200. The client 200 provides a predetermined service to a user by, for example, performing communication with the terminal device 40 or controlling the terminal device 40.

The base station 20 is a wireless communication device that performs wireless communication with the terminal device 40. The base station 20 is a type of communication device. The base station 20 is a type of information processing device.

The terminal device 40 is a wireless communication device that performs wireless communication with the base station 20. The terminal device 40 is, for example, a mobile phone, a smart device (smartphone or tablet PC), a personal digital assistant (PDA), or a personal computer. For example, the terminal device 40 may be a machine to machine (M2M) device or an Internet of Things (IoT) device. Furthermore, the terminal device 40 may be a head mounted display, VR goggles, or the like. The terminal device 40 may be a mobile body such as a vehicle (automobile) or a drone.

For example, in a case where the terminal device 40 is a mobile phone, the client 200 provides a predetermined service to the user who uses the terminal device 40. Furthermore, in a case where the terminal device 40 is an M2M device, an IoT device, or the like, the client 200 acquires data from the terminal device 40 or controls the terminal device 40, thereby providing a predetermined service to the user.

As illustrated in FIG. 1, the RAMNF 100 acquires first information regarding the terminal device 40 from the core network CN via a service based interface (SBI) (Step S1). The first information includes, for example, registration information (for example, registered/de-registered, connected/idle, or the like) regarding registration of the terminal device 40.

The RAMNF 100 acquires terminal-related information acquired from the terminal device 40 directly or via the SBI (Step S2). The RAMNF 100 acquires measurement information measured based on the first information (Step S3). Note that the RAMNF 100 may acquire at least one of the terminal-related information or the measurement information. Hereinafter, the measurement information and/or the terminal-related information are also collectively referred to as second information.

The measurement information includes information regarding a transition interval of registration of the terminal device 40 calculated based on the registration information. The terminal-related information includes, for example, information included in an application layer of the terminal device 40. More specifically, the terminal-related information includes, for example, at least one of schedule information regarding a registration schedule, power information regarding power consumption of the terminal device 40, and location information regarding a location of the terminal device 40.

The RAMNF 100 specifies the terminal device 40 from the second information or by associating the first information and the second information with each other (Step S4). The RAMNF 100 specifies the terminal device 40 by using, for example, the second information and/or information (for example, a UE ID such as an international mobile subscriber identity (IMSI) or a subscription permanent identifier (SUPI)) for specifying the terminal device 40 included in the first information. The RAMNF 100 notifies the client 200 of at least one of the first information or the second information in association with the specified terminal device 40 (Step S5).

As a result, the client 200 can acquire more detailed information of the terminal device 40, and can more appropriately communicate with the terminal device 40. For example, the client 200 can select a terminal device 40 located in a predetermined area to perform communication, or can select a terminal device 40 with sufficient power remaining to perform communication.

### 2. Configuration of Communication System

### 2.1. Example of Configuration of Information Processing Device

The information processing device 10 is an information processing device (computer) connected to a network N (see FIG. 1). For example, the information processing device 10 is an information processing device that implements at least a part of the function of the core network CN. For example, the information processing device 10 is an information processing device that implements at least a part of the function of the RAMNF 100. For example, the information processing device 10 is an information processing device that implements at least a part of the function of the client 200.

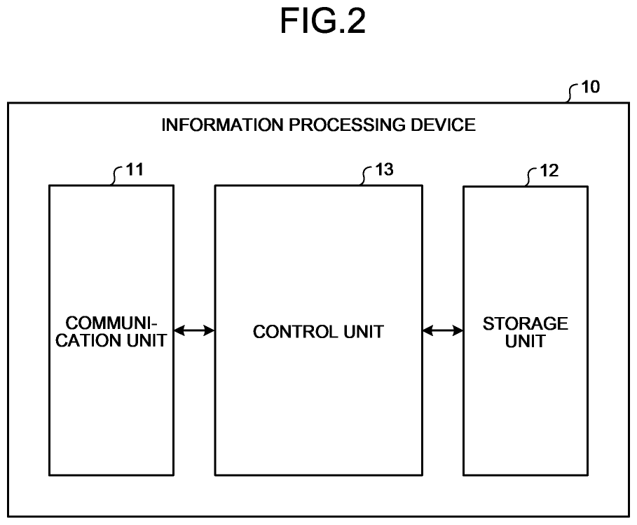

FIG. 2 is a diagram illustrating an example of a configuration of the information processing device 10 according to an embodiment of the present disclosure. The information processing device 10 includes a communication unit 11, a storage unit 12, and a control unit 13. Note that the configuration illustrated in FIG. 2 is a functional configuration, and a hardware configuration may be different from this. Furthermore, the functions of the information processing device 10 may be statically or dynamically distributed to and implemented in a plurality of physically separated components. For example, the information processing device 10 may be implemented by a plurality of server devices.

The communication unit 11 is a communication interface for performing communication with another device. The communication unit 11 may be a network interface or may be an equipment connection interface. For example, the communication unit 11 may be a local area network (LAN) interface such as a network interface card (NIC), or may be a universal serial bus (USB) interface including a USB host controller, a USB port, and the like. Further, the communication unit 11 may be a wired interface or a wireless interface. The communication unit 11 functions as communication means of the information processing device 10. The communication unit 11 communicates with another information processing device 10, the base station 20, and the like under the control of the control unit 13.

The storage unit 12 is a storage device, from which data can be read and in which data can be written, such as a dynamic random access memory (DRAM), a static random access memory (SRAM), a flash memory, or a hard disk. The storage unit 12 functions as storage means of the information processing device 10.

The control unit 13 is a controller that controls each unit of the information processing device 10. The control unit 13 is implemented by, for example, a processor such as a central processing unit (CPU), a micro processing unit (MPU), or a graphics processing unit (GPU). For example, the control unit 13 is implemented in a manner in which the processor executes various programs stored in the storage device inside the information processing device 10 by using a random access memory (RAM) or the like as a work area. Note that the control unit 13 may be implemented by an integrated circuit such as an application specific integrated circuit (ASIC) or a field programmable gate array (FPGA). The CPU, the MPU, the GPU, the ASIC, and the FPGA can all be regarded as the controller.

### 2.2. Example of Configuration of Base Station

The base station 20 is a communication device that operates a cell and provides a wireless communication service to one or more terminal devices 40 located inside the coverage of the cell. The cell can be operated according to any wireless communication scheme such as LTE or New Radio (NR). The base station 20 is connected to the core network CN. The core network CN is connected to a packet data network via a gateway device.

Note that the base station 20 may include a set of a plurality of physical or logical devices. For example, in an embodiment of the present disclosure, the base station 20 is classified into a plurality of devices including a baseband unit (BBU) and a radio unit (RU), and may be interpreted as a set of these plurality of devices. In addition or instead, in the embodiments of the present disclosure, the base station 20 may be either or both of the BBU and the RU. The BBU and the RU may be connected by a predetermined interface (for example, eCPRI). In addition or instead, the RU may be referred to as a remote radio unit (RRU) or a Radio DoT (RD). In addition or instead, the RU may correspond to a gNB distributed unit (gNB-DU) described below. In addition or instead, the BBU may correspond to a gNB-CU described below. Instead, the RU may be connected to the gNB-DU described below. In addition, the BBU may correspond to a combination of the gNB-CU and the gNB-DU described below. In addition or instead, the RU may be a device integrally formed with an antenna. An antenna of the base station 20 (for example, the antenna integrally formed with the RU) may adopt an advanced antenna system and support MIMO (for example, FD-MIMO) or beamforming. In the advanced antenna system, the antenna of the base station 20 (for example, the antenna integrally formed with the RU) may include, for example, 64 transmission antenna ports and 64 reception antenna ports.

Further, a plurality of base stations 20 may be connected to each other. One or more base stations 20 may be included in the radio access network (RAN). That is, the base station 20 may be simply referred to as a RAN, a RAN node, an access network (AN), or an AN node. The RAN in the LTE is referred to as an enhanced universal terrestrial RAN (EUTRAN). The RAN in the NR is referred to as an NGRAN. The RAN in W-CDMA (UMTS) is referred to as a UTRAN. The base station 20 in the LTE is referred to as an evolved node B (eNodeB) or an eNB. That is, the EUTRAN includes one or more eNodeBs (eNBs). Further, the base station 20 in the NR is referred to as a gNodeB or a gNB. That is, the NGRAN includes one or more gNBs. Further, the EUTRAN may include a gNB (ng-eNB) connected to the core network (EPC) in the communication system (EPS) of the LTE. Similarly, the NGRAN may include a gNB connected to the core network (5GC) in the 5G communication system (5GS). In addition or instead, in a case where the base station 20 is an eNB, a gNB, or the like, the base station may be referred to as 3GPP access. In addition or instead, in a case where the base station 20 is a wireless access point (e.g., an access point of WiFi (registered trademark)), the base station 20 may be referred to as non-3GPP access. In addition or instead, the base station 20 may be an optical feeder device which is called a remote radio head (RRH). In addition or instead, in a case where the base station 20 is a gNB, the base station 20 may be referred to as a combination of a gNB central unit (CU) and a gNB distributed unit (DU) described above or any of them. The gNB central unit (CU) hosts a plurality of higher layers (for example, radio resource control (RRC), service data adaptation protocol (SDAP), and PDCP) of the access stratum for communication with the UE. On the other hand, the gNB-DU hosts a plurality of lower layers (for example, RLC, MAC, and PHY) of the access stratum. That is, among messages and information to be described later, RRC signaling (for example, various system information blocks (SIB) including a master information block (MIB) and an SIB1, an RRCSetup message, and an RRCReconfiguration message) may be generated by the gNB CU, while a downlink control indicator (DCI) and various physical channels (for example, a PDCCH and a PBCH) to be described later may be generated by the gNB-DU. Alternatively, in the RRC signaling, for example, some configurations (configuration information) such as IE: cellGroupConfig may be generated by the gNB-DU, and the remaining configurations may be generated by the gNB-CU. These configurations (configuration information) may be transmitted and received by an F1 interface to be described later. The base station 20 may be configured to be able to perform communication with another base station 20. For example, in a case where a plurality of base stations 20 are eNBs or a combination of eNBs and gn-eNBs, the base stations 20 may be connected by an X2 interface. In addition or instead, in a case where a plurality of base stations 20 are eNBs or a combination of gn-eNBs and gNBs, the devices may be connected by an Xn interface. In addition or instead, in a case where a plurality of base stations 20 are a combination of gNB CUs and gNB DUs, the devices may be connected by the above-described F1 interface. The messages/information (RRC signaling, DCI information, or physical channel) to be described later may be communicated between a plurality of base stations 20 (for example, via the X2, Xn, or F1 interface).

Further, as described above, the base station 20 may be configured to manage a plurality of cells. A cell provided by the base station 20 is called a serving cell. The serving cell includes a primary cell (PCell) and a secondary cell (SCell). In a case where Dual Connectivity (for example, EUTRA-EUTRA Dual Connectivity, EUTRA-NR Dual Connectivity (ENDC), EUTRA-NR Dual Connectivity with 5GC, NREUTRA Dual Connectivity (NEDC), or NR-NR Dual Connectivity) is provided to the UE (for example, terminal device 40), the PCell and zero or one or more SCells provided by a master node (MN) are referred to as a master cell group. Further, the serving cell may include a primary secondary cell or a primary SCG Cell (PSCell). That is, in a case where the Dual Connectivity is provided to the UE, the PSCell and zero or one or more SCells provided by a secondary node (SN) are referred to as a secondary cell group (SCG). Unless specially configured (for example, physical uplink control channel (PUCCH) on SCell), the PUCCH is transmitted by the PCell and the PSCell, not by the SCell. Radio link failure is detected in the PCell and the PSCell, and is not detected (does not have to be detected) in the SCell. Since the PCell and the PSCell have a special role in the serving cell(s) as described above, they are also called special cells (SpCells). One downlink component carrier and one uplink component carrier may be associated with one cell. Further, a system bandwidth corresponding to one cell may be divided into a plurality of bandwidth parts. In this case, one or more bandwidth parts (BWPs) may be set in the UE and one bandwidth part may be used in the UE as an active BWP. Further, radio resources (for example, a frequency band, numerology (subcarrier spacing), and slot configuration) that can be used by the terminal device 40 may be different for each cell, each component carrier, or each BWP.

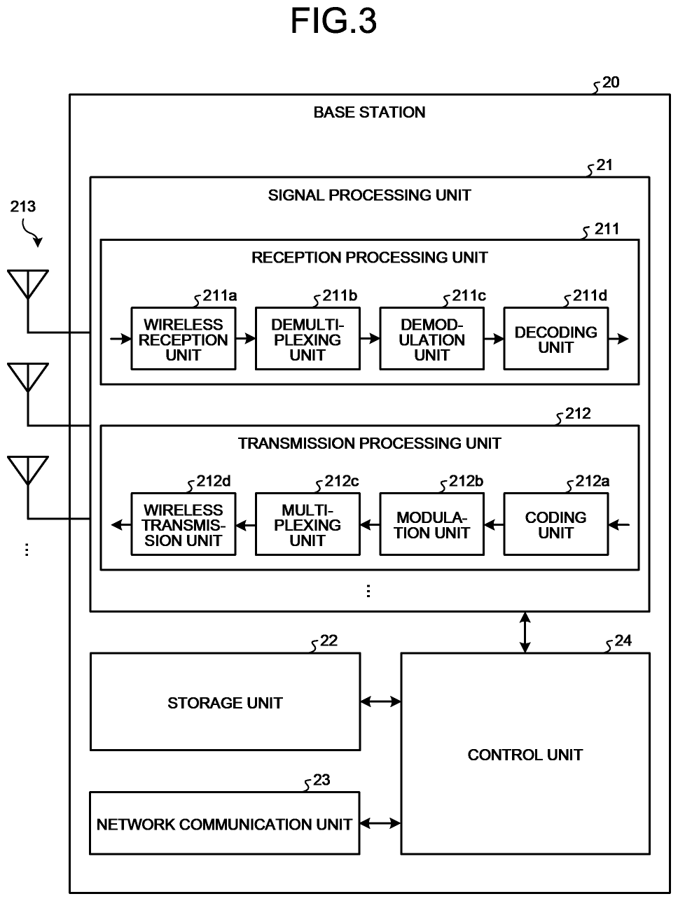

FIG. 3 is a diagram illustrating an example of a configuration of the base station 20 according to an embodiment of the present disclosure. The base station 20 is a communication device (wireless system) that performs wireless communication with the terminal device 40. The base station 20 is a type of information processing device.

The base station 20 includes a signal processing unit 21, a storage unit 22, a network communication unit 23, and a control unit 24. Note that the configuration illustrated in FIG. 3 is a functional configuration, and a hardware configuration may be different from this. Further, the functions of the base station 20 may be distributed to and implemented in a plurality of physically separated devices.

The signal processing unit 21 is a wireless communication interface that performs wireless communication with other communication devices (for example, the terminal device 40 and another base station 20). The signal processing unit 21 is a wireless transceiver that operates under the control of the control unit 24. The signal processing unit 21 may support a plurality of radio access schemes. For example, the signal processing unit 21 may support both NR and LTE. The signal processing unit 21 may support another cellular communication scheme such as W-CDMA or cdma2000. Further, the signal processing unit 21 may support a wireless LAN communication scheme in addition to the cellular communication scheme. It is a matter of course that the signal processing unit 21 may only support one radio access scheme.

The signal processing unit 21 includes a reception processing unit 211, a transmission processing unit 212, and an antenna 213. The signal processing unit 21 may include a plurality of reception processing units 211, a plurality of transmission processing units 212, and a plurality of antennas 213. Note that, in a case where the signal processing unit 21 supports a plurality of radio access schemes, each unit of the signal processing unit 21 can be individually configured for each radio access scheme. For example, in a case where the base station 20 supports NR and LTE, the reception processing unit 211 and the transmission processing unit 212 may be individually configured for each of NR and LTE.

The reception processing unit 211 processes an uplink signal received via the antenna 213. The reception processing unit 211 includes a wireless reception unit 211a, a demultiplexing unit 211b, a demodulation unit 211c, and a decoding unit 211d.

The wireless reception unit 211a performs, on the uplink signal, down-conversion, removal of an unnecessary frequency component, a control of an amplification level, quadrature demodulation, conversion into a digital signal, removal of a guard interval, extraction of a frequency domain signal by fast Fourier transform, and the like. For example, it is assumed that the radio access scheme of the base station 20 is a cellular communication scheme such as LTE. At this time, the demultiplexing unit 211b separates an uplink channel such as a physical uplink shared channel (PUSCH) or physical uplink control channel (PUCCH) and an uplink reference signal from a signal output from the wireless reception unit 211a. The demodulation unit 211c performs demodulation of a reception signal for a modulation symbol of the uplink channel by using a modulation scheme such as binary phase shift keying (BPSK) or quadrature phase shift keying (QPSK). The modulation scheme used by the demodulation unit 211c may be multi-level QAM such as 16-quadrature amplitude modulation (QAM), 64-QAM, or 256-QAM. The decoding unit 211d performs decoding processing on a coded bit of the demodulated uplink channel. Decoded uplink data and uplink control information are output to the control unit 24.

The transmission processing unit 212 performs transmission processing of downlink control information and downlink data. The transmission processing unit 212 includes a coding unit 212a, a modulation unit 212b, a multiplexing unit 212c, and a wireless transmission unit 212d.

The coding unit 212a codes the downlink control information and the downlink data input from the control unit 24 by using a coding method such as block coding, convolutional coding, or turbo coding. The modulation unit 212b modulates the coded bit output from the coding unit 212a by a predetermined modulation scheme such as BPSK, QPSK, 16-QAM, 64-QAM, or 256-QAM. The multiplexing unit 212c multiplexes a modulation symbol of each channel and a downlink reference signal, and maps them to a predetermined resource element. The wireless transmission unit 212d performs various kinds of signal processing on a signal from the multiplexing unit 212c. For example, the wireless transmission unit 212d performs processing such as conversion into the time domain by fast Fourier transform, addition of a guard interval, generation of a baseband digital signal, conversion into an analog signal, quadrature modulation, up-conversion, removal of extra frequency components, or power amplification. A signal generated by the transmission processing unit 212 is transmitted from the antenna 213.

The storage unit 22 is a storage device, from which data can be read and in which data can be written, such as a DRAM, an SRAM, a flash memory, or a hard disk. The storage unit 22 functions as a storage means of the base station 20.

The network communication unit 23 is a communication interface for communicating with other devices (for example, another base station 20). For example, the network communication unit 23 is a local area network (LAN) interface such as a network interface card (NIC). The network communication unit 23 may be a universal serial bus (USB) interface including a USB host controller, a USB port, and the like. Further, the network communication unit 23 may be a wired interface or a wireless interface. The network communication unit 23 functions as a network communication means of the base station 20. The network communication unit 23 performs communication with another device under the control of the control unit 24.

The control unit 24 is a controller that controls each unit of the base station 20. The control unit 24 is implemented by, for example, a processor such as a central processing unit (CPU) or a micro processing unit (MPU). For example, the control unit 24 is implemented in a manner in which the processor executes various programs stored in the storage device inside the base station 20 by using a random access memory (RAM) or the like as a work area. Note that the control unit 24 may be implemented by an integrated circuit such as an application specific integrated circuit (ASIC) or a field programmable gate array (FPGA). The CPU, the MPU, the ASIC, and the FPGA can all be regarded as the controller.

### 2.3. Example of Configuration of Terminal Device

The terminal device 40 is a communication device that performs wireless communication with the base station 20 under the control of the base station 20.

The terminal device 40 is a wireless communication device that performs wireless communication with other devices. The terminal device 40 is, for example, a sensor or a camera device having a communication function, a mobile phone, a smart device (smartphone or tablet PC), a personal digital assistant (PDA), or a personal computer. The terminal device 40 may be a head mounted display having a function of wirelessly transmitting and receiving data, VR goggles, or the like. The terminal device 40 may be a mobile body such as an automobile or a drone.

For example, the terminal device 40 performs wireless communication with another terminal device 40 under the control of the base station 20 or autonomously. In this case, the terminal device 40 transmits a sidelink signal to another terminal device 40 and receives a sidelink signal from another terminal device 40 in PC5 link. Transmission and reception of the sidelink signal by the terminal device 40 will be collectively referred to as sidelink communication. When performing the sidelink communication, the terminal device 40 may be able to use automatic retransmission technology such as hybrid automatic repeat request (HARQ).

The terminal device 40 may be capable of non-orthogonal multiple access (NOMA) communication with the base station 20. The terminal device 40 may also be able to perform the NOMA communication for communication (sidelink) with another terminal device 40. Furthermore, the terminal device 40 may be able to perform low power wide area (LPWA) communication with another communication device (for example, the base station 20 and another terminal device 40). In addition, wireless communication used by the terminal device 40 may be wireless communication using millimeter waves or terahertz waves. Note that the wireless communication (including the sidelink communication) used by the terminal device 40 may be wireless communication using radio waves or may be (optical) wireless communication using infrared rays or visible light.

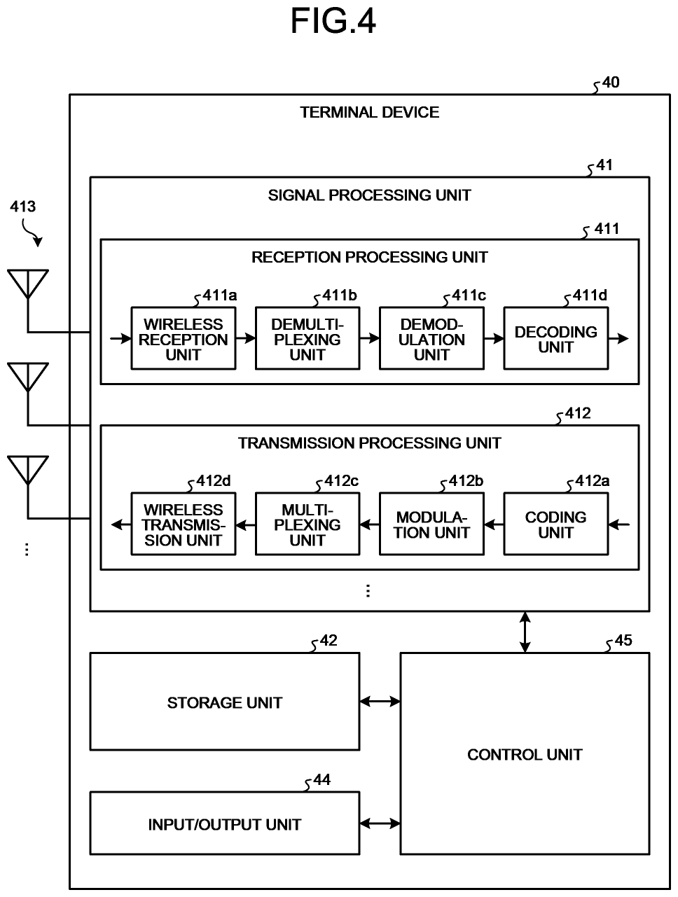

FIG. 4 is a diagram illustrating an example of the configuration of the terminal device 40 according to an embodiment of the present disclosure. The terminal device 40 is a communication device (wireless system) that performs wireless communication with the base station 20. The terminal device 40 is a type of information processing device.

The terminal device 40 includes a signal processing unit 41, a storage unit 42, an input/output unit 44, and a control unit 45. Note that the configuration illustrated in FIG. 4 is a functional configuration, and a hardware configuration may be different from this. Further, the functions of the terminal device 40 may be distributed to and implemented in a plurality of physically separated components.

The signal processing unit 41 is a wireless communication interface that performs wireless communication with other communication devices (for example, the base station 20 and another terminal device 40). The signal processing unit 41 is a wireless transceiver that operates under the control of the control unit 45. The signal processing unit 41 supports one or more radio access schemes. For example, the signal processing unit 41 supports both NR and LTE. The signal processing unit 41 may support another radio access scheme such as W-CDMA or cdma2000.

The signal processing unit 41 includes a reception processing unit 411, a transmission processing unit 412, and an antenna 413. The signal processing unit 41 may include a plurality of reception processing units 411, a plurality of transmission processing units 412, and a plurality of antennas 413. Note that, in a case where the signal processing unit 41 supports a plurality of radio access schemes, each unit of the signal processing unit 41 can be individually configured for each radio access scheme. For example, the reception processing unit 411 and the transmission processing unit 412 may be individually configured for each of LTE and NR. The configurations of the reception processing unit 411 and the transmission processing unit 412 are similar to those of the reception processing unit 211 and the transmission processing unit 212 of the base station 20.

The storage unit 42 is a storage device, from which data can be read and in which data can be written, such as a DRAM, an SRAM, a flash memory, or a hard disk. The storage unit 42 functions as storage means of the terminal device 40.

The input/output unit 44 is a user interface for exchanging information with the user. For example, the input/output unit 44 is an operation device for the user to perform various operations, such as a keyboard, a mouse, an operation key, or a touch panel. Alternatively, the input/output unit 44 is a display device such as a liquid crystal display or an organic electroluminescence (EL) display. The input/output unit 44 may be an audio device such as a speaker or a buzzer. Further, the input/output unit 44 may be a lighting device such as a light emitting diode (LED) lamp. The input/output unit 44 functions as input/output means (input means, output means, operation means, or notification means) of the terminal device 40.

The control unit 45 is a controller that controls each unit of the terminal device 40. The control unit 45 is implemented by, for example, a processor such as a CPU or an MPU. For example, the control unit 45 is implemented in a manner in which the processor executes various programs stored in the storage device inside the terminal device 40 by using a RAM or the like as a work area. Note that the control unit 45 may be implemented by an integrated circuit such as an ASIC or a FPGA. The CPU, the MPU, the ASIC, and the FPGA can all be regarded as the controller.

### 3. Network Architecture

The configuration of the information processing system 1 has been described above. Next, a network architecture applicable to the information processing system 1 of the present embodiment will be described. An architecture of a fifth generation mobile communication system (5G) will be described below as an example of the core network CN of the information processing system 1. The 5G architecture described herein is described, for example, in 3GPP TS23.501.

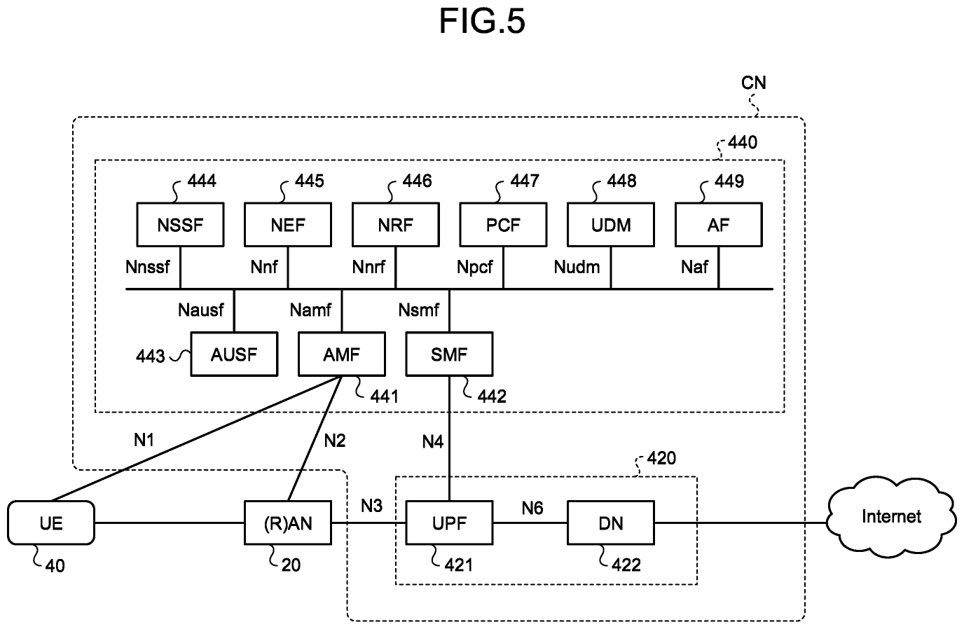

FIG. 5 is a diagram illustrating an example of the 5G architecture. The core network CN of 5G is also referred to as 5G core/next generation core (5GC/NGC). Hereinafter, the core network CN of 5G is also referred to as the 5GC/NGC. The core network CN is connected to a user equipment (UE) 40 via a (R)AN 20. The UE 40 is, for example, the terminal device 40.

The (R)AN 20 has a function of enabling connection to a radio access network (RAN) and connection to an access network (AN) other than the RAN. The (R)AN 20 includes the base station 20 called a gNB or an ng-eNB.

The core network CN mainly performs connection permission and session management when the UE 40 is connected to the network. The core network CN can include a user plane function group 420 and a control plane function group 440.

The user plane function group 420 includes a user plane function (UPF) 421 and a data network (DN) 422. The UPF 421 has a user plane processing function. The UPF 421 has a function of routing/forwarding data handled in user plane. The DN 422 is, for example, an entity that provides access to a service unique to an operator such as a mobile network operator (MNO), and has a function of providing Internet connection providing access to a service of a third party. As described above, the user plane function group 420 plays a role of a gateway serving as a boundary between the core network CN and the Internet.

The control plane function group 440 includes an access management function (AMF) 441, a session management function (SMF) 442, an authentication server function (AUSF) 443, a network slice selection function (NSSF) 444, a network exposure function (NEF) 445, a network repository function (NRF) 446, a policy control function (PCF) 447, a unified data management (UDM) 448, and an application function (AF) 449.

The AMF 441 has functions such as registration processing, connection management, and mobility management for the UE 40. The SMF 442 has functions such as session management and IP assignment and management for the UE 40. The AUSF 443 has an authentication function. The NSSF 444 has a function related to selection of a network slice. The NEF 445 has a function of providing network function capabilities and events to a third party, the AF 449, and an edge computing function.

The NRF 446 has a function of finding a network function and holding a profile of the network function. The PCF 447 has a policy control function. The UDM 448 has functions of generating 3GPP AKA authentication information and processing a user ID. The AF 449 has a function of interacting with the core network CN to provide a service.

For example, the control plane function group 440 acquires information from the UDM 448 in which subscriber information of the UE 40 is stored, and determines whether or not the UE 40 may be connected to the network. The control plane function group 440 uses contract information of the UE 40 included in the information acquired from the UDM 448 and a key for encryption for such determination. In addition, the control plane function group 440 generates the key for encryption and the like.

That is, the control plane function group 440 determines whether or not connection to the network can be made according to whether or not information of the UE 40 associated with a subscriber number called international mobile subscriber identity (IMSI) is stored in the UDM 448, for example. Note that the IMSI is stored in, for example, a subscriber identity module (SIM) card in the UE 40.

Here, Namf is a service-based interface provided by the AMF 441, and Nsmf is a service-based interface provided by the SMF 442. In addition, Nnef is a service-based interface provided by the NEF 445, and Npcf is a service-based interface provided by the PCF 447. Nudm is a service-based interface provided by the UDM 448, and Naf is a service-based interface provided by the AF 449. Nnrf is a service-based interface provided by the NRF 446, and Nnssf is a service-based interface provided by the NSSF 444. Nausf is a service-based interface provided by the AUSF 443. Each of the network functions (NF) exchanges information with another NF via each service-based interface.

In addition, N1 illustrated in FIG. 5 is a reference point between the UE 40 and the AMF 441, and N2 is a reference point between the (R)AN 20 and the AMF 441. N4 is a reference point between the SMF 442 and the UPF 421, and information is exchanged between the network functions (NFs).

As described above, in the core network CN, an interface that transmits information and controls functions via an application programming interface (API) called a service-based interface (SBI) is prepared.

The API specifies a resource and enables GET (resource acquisition), POST (resource creation and data addition), PUT (resource creation and resource update), DELETE (resource deletion), and the like for the resource. Such a function is generally used, for example, in the technical field related to the web.

For example, the AMF 441, the SMF 442, and the UDM 448 illustrated in FIG. 5 transmit and receive information with each other by using the API in a case of establishing a communication session. Hitherto, it has not been assumed that an application (for example, the AF 449) uses such an API. However, as the AF 449 uses such an API, the AF 449 can use information of a 5G cellular network, and it is considered that a function of the application can be further evolved.

Note that it is difficult for the AF 449 to use the API used by the AMF 441, the SMF 442, and the UDM 448 in a public network. However, in a case of a non-public private 5G network, it is considered that the system can include, for example, a modification of the API of the core network CN so that the AF 449 can use such an API.

### (Private 5G)

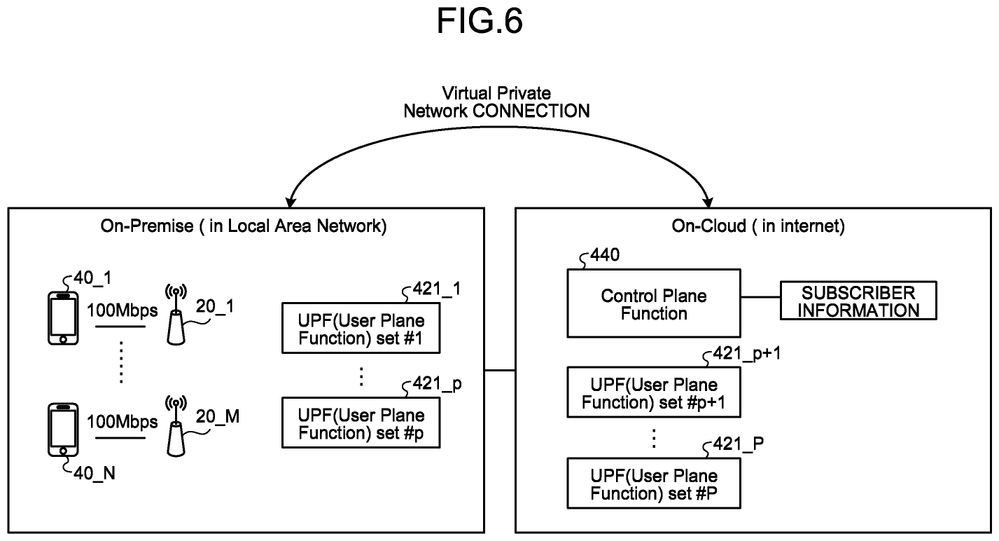

Here, an example of the non-public private 5G network will be described. FIG. 6 is a diagram for describing an example of a configuration of the private 5G network according to an embodiment of the present disclosure.

Currently, a local area network (LAN) is arranged in many offices and homes. The LAN includes, for example, an Ethernet cable, a router, or the like. The LAN is connected to the Internet by using a service of an Internet service provider (ISP). The LAN and a cloud are connected via, for example, a virtual private network (VPN). In the VPN, a packet is basically routed by a private IP address. In a case where a packet is transmitted outside the VPN, the packet is transmitted outside the VPN via a gateway router (not illustrated).

The private 5G is operated by placing the cellular base station 20 in the LAN. That is, in the private 5G, a plurality of base stations 20_1 to 20_M (M is a natural number), a plurality of UEs 40_1 to 40_N (N is a natural number), and some functions of the core network CN are arranged in the LAN. In addition, the remaining functions of the core network CN are arranged, for example, in a data center of the cloud of the Internet line.

In the example of FIG. 6, UPFs 421_1 to 421_p (p is a natural number, and p≤P) are arranged in the LAN. UPFs 421_p+1 to 421_P (P is a natural number) are arranged in the cloud of the Internet line. Note that, here, the UPF 421 is arranged in the LAN or/and the cloud, but instead of this, the user plane function group 420 may be arranged in the LAN or/and the cloud.

In addition, the control plane function group 440 (hereinafter, also referred to as CPF 440) is arranged in the Cloud of the Internet line.

As described above, in the private 5G, the base station 20 and the UE 40 are arranged in an office, a factory, or a private residence where the LAN is arranged. Meanwhile, the core network CN that controls the base station 20 may be arranged in the LAN or may be arranged in the data center of the cloud in the Internet. Note that FIG. 6 is an example, and at least some functions of the CPF 440 may be arranged in the LAN. In addition, all the UPFs 421 may be arranged in the LAN, or may be arranged in the cloud.

A private IP address is assigned to the base station 20 and the core network CN. The base station 20 and the core network CN are arranged in an environment in which the base station 20 and the core network CN can communicate with each other. For example, by using a technology such as the VPN, the base station 20 and the core network CN can communicate with each other using the private IP address.

That is, a network connecting the base station 20 and the core network CN can be treated as a private network.

Note that the UPFs 421_1 to 421_p arranged in the LAN exist in the LAN when the CPF 440 is started or when the operation of the core network CN is started. On the other hand, the UPFs 421_p+1 to 421_P arranged in the cloud do not exist in the Cloud when the CPF 440 is started or when the operation of the core network CN is started. The UPFs 421_p+1 to 421_P are, for example, a function that is started after the CPF 440 is started or after the operation of the core network CN is started.

In summary, the private 5G may be a non-public network. In practice, there is a high possibility that the UE 40, the base station 20, the core network CN, and the application having the client function are arranged inside the VPN. The UE 40 and the base station 20 are arranged in the LAN. The core network CN and the application may be arranged in either the LAN or the cloud of the Internet.

### (API)

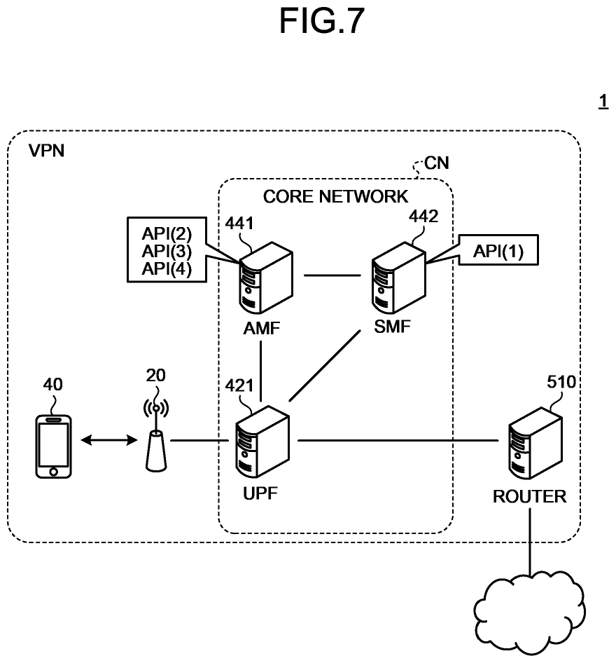

Here, an example of the API will be described. FIG. 7 is a diagram for describing the API according to an embodiment of the present disclosure. API(1) to API(4) described here are described in 3GPP TS23.502.

As described above, the UE 40, the base station 20, and the core network CN are arranged in the virtual LAN (VPN 500). The base station 20 and the core network CN communicate with a network outside the VPN (for example, the Internet) via a gateway router 510.

### API(1)

API(1) is an API with which the SMF 442 makes a notification of the fact that the UE 40 registered in advance transitions from a power-off state to a power-on state and is attached to the network, and an IP address acquired at that time.

The SMF 442 notifies the NF when the UE 40 of the registered IMSI obtains the IP address, by using API(1).

### API(2)

The UE 40 enters an idle mode in a case where communication is not performed, and transitions to a connected mode in a case where communication is performed. API(2) is an API with which the AMF 441 makes a notification of whether the UE 40 is in the idle mode or the connected mode.

### API(3)

API(3) is an API for broadcasting, from the base station 20, a message (paging message) for instructing the UE 40 to transition from the idle mode to the connected mode. API(3) can be used, for example, when a packet addressed to the UE 40 in the idle mode arrives at the UPF 421.

### API(4)

API(4) is an API with which the AMF 441 provides the location information of the UE 40. The AMF 441 may use the API(4) to inform which tracking area the UE 40 is in, which cell the UE 40 belongs to, and the fact that the UE 40 enters a specific region when the UE 40 enters the specific region.

Note that the location information obtained by using API(4) is, for example, information with lower accuracy than location information obtained by the global positioning system (GPS). For example, the location information obtained by the GPS is information in units of longitude and latitude, whereas the location information obtained by using API(4) is, for example, information in units of cells of the base stations 20.

For example, the location information obtained by the GPS is location information of the application layer of the UE 40 on which the GPS is mounted. On the other hand, the location information obtained by API(4) is location information provided from 3GPP RAN 1 by the AMF 441. An API(API(4)) for acquiring location information of 3GPP RAN 1 is provided in the AMF 441.

Note that an example of the UE 40 of FIG. 5 is the terminal device 40 of the present embodiment. An example of the (R)AN 20 is the base station 20 of the present embodiment. Furthermore, the information processing device 10 illustrated in FIG. 2 is an example of a device having each function of the core network CN, for example.

### 4. Technical Features

### 4.1. RAMNF

### 4.1.1. Outline of RAMNF

Here, in the conventional 5G, the network function (NF) of the core network CN uses an API of a 5G service based interface. In the present embodiment, as a platform called the RAMNF 100 is provided, the service and the application, that is, the client 200 and the terminal device 40 can more easily obtain the information of the core network CN. As a result, the service provided by the client 200 can be further evolved.

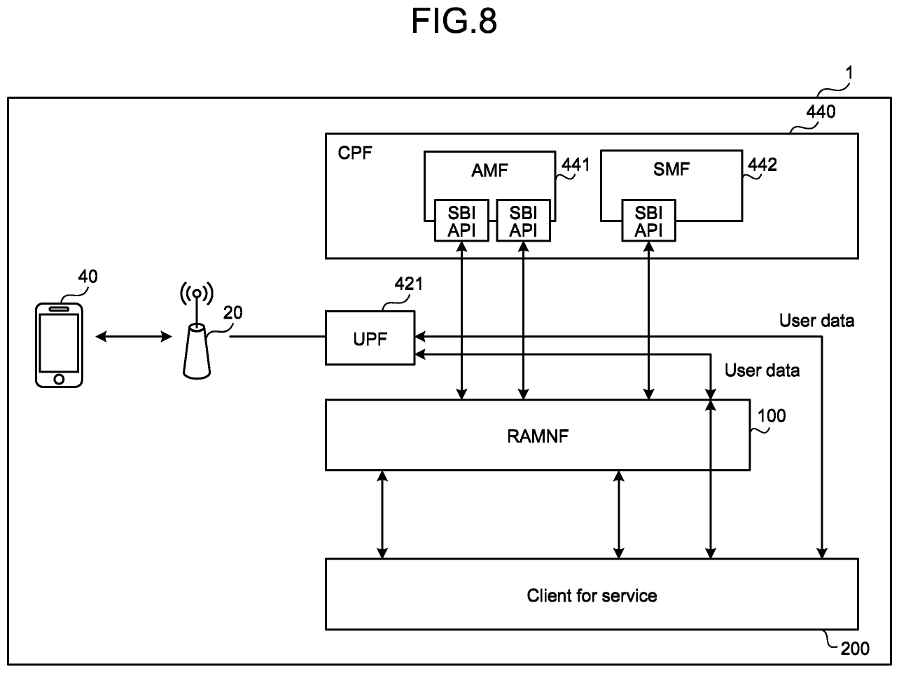

FIG. 8 is a diagram illustrating an example of the information processing system 1 according to an embodiment of the present disclosure. As illustrated in FIG. 8, the client 200 for the service transmits and receives user data with the UPF 421 via the RAMNF 100 or directly. In addition, the client 200 communicates with the CPF 440 via the RAMNF 100. The RAMNF 100 performs communication with the AMF 441 and the SMF 442 via an SBI API.

For example, the service-side client 200 inquires of the RAMNF 100 about a status of a target terminal device 40 (that is, a terminal device 40 with which communication is to be performed) before communicating with the terminal device 40.

In a case where a result of the inquiry indicates that the terminal device 40 is deregistered (a state in which the IP address is not assigned), the client 200 does not perform communication with the terminal device 40. As a result, the client 200 can refrain from transmitting an unnecessary packet.

Furthermore, even in a case where the terminal device 40 is registered (a state in which the IP address is assigned), when the terminal device 40 is in the idle status, the client 200 can be prevented from performing communication with the terminal device 40.

When a packet is transmitted to the terminal device 40 in the idle status, paging is automatically transmitted to the terminal device 40, and the terminal device 40 is activated (transitions to the connected status). For example, in a case where the terminal device 40 is a low power consumption type device, the client 200 can refrain from transmitting a packet to the terminal device 40 in the idle status and transmit a packet to the terminal device 40 in the connected status. As a result, the client 200 can prevent the terminal device 40 from being unnecessarily activated, and the power consumption of the terminal device 40 can be further reduced.

Furthermore, in a case where the terminal device 40 is not a low power consumption type device, the client 200 can transmit a packet to the terminal device 40 in the idle status. At this time, for example, it is assumed that the client 200 transmits the paging message to the terminal device 40 in advance by using the API of the AMF 441 via the RAMNF 100 before transmitting the packet.

For example, in a normal cellular system, the client 200 transmits a packet to the terminal device 40 in the idle status without causing the terminal device 40 transition to the connected status. In this case, after the packet arrives at the UPF 421, the paging message for causing the terminal device 40 to transition to the connected status is transmitted. Therefore, in a normal cellular system, a large delay occurs when a packet is transmitted to the terminal device 40 in the idle status.

On the other hand, as described above, as the RAMNF 100 is used, the client 200 according to the present embodiment can make the status of the terminal device 40 transition to the connected status before actually transmitting a packet to the terminal device 40. As a result, the client 200 can further reduce a packet delay time.

### 4.1.2. Problem of RAMNF

It is considered that there is an increasing demand for obtaining more detailed information of the network (for example, the core network CN) by the client 200 providing the service. This is because a service quality that is higher than before (for example, low delay and low power consumption) is expected by cooperation between the network and the service.

As described above, in order for the RAMNF 100 to transmit more detailed information of the network to the client 200, the RAMNF 100 is required to collect more detailed information of the network.

Here, the network includes, for example, at least one of the following statuses.
Status of base station 20
Status of core network CN
Status of terminal device 40
Traffic status
Status of capability of at least one of base station 20, core network CN, or terminal device 40

A mechanism for collecting more detailed information regarding these Statuses is required.

Next, the RAMNF 100 can be required to more efficiently deliver information regarding the network to the client 200. For example, the RAMNF 100 transmits information regarding a plurality of terminal devices 40 as a group to the client 200, so that the client 200 can more appropriately grasp the information of the network in some cases.

Finally, there may be a case where the client 200 desires to control the status of the network in more detail. This is because it may be more beneficial for the service if the network operates as desired by the client 200.

As described above, it is desirable that the RAMNF 100 further has the following functions.
(1) Function of collecting more detailed information of network
(2) Function of providing information of network to client 200 in easy-to-understand manner
(3) Function for performing control by client 200 in more detail

Hereinafter, more detailed problems and solutions for implementing these functions will be described. Note that, since (1) and (2) can operate integrally, the problems and solutions of (1) and (2) can be simultaneously described.

### 4.2. First Embodiment

### 4.2.1. First Problem

It is desirable that the client 200 can know a time after which the terminal device 40 transitions from the connected mode (status) to the idle mode (status) if no communication is performed. That is, it cannot be said that the client 200 can properly grasp the information of the network. In other words, it is desirable to enable the RAMNF 100 to collect more detailed registration information regarding the registration of the terminal device 40.

As the API of the 5G SBI, for example, the API of paging (a function of calling the terminal device 40 in the idle mode) of the AMF 441, is used, the RAMNF 100 can instruct the terminal device 40 in the idle mode to transition to the connected mode.

Here, the idle mode means an RRC idle status, and means a state in which a wireless section between the terminal device 40 and the base station 20 is disconnected. In addition, the connected mode means an RRC connected status, and means a state in which the wireless section between the terminal device 40 and the base station 20 is connected.

The RAMNF 100 can cause the terminal device 40 transition to the connected mode by activating the API of the AMF 441 in response to a request from the client 200. As a result, the RAMNF 100 can cause a counterpart terminal device 40 with which the client 200 desires to communicate to transition to the connected mode in advance at a timing when the client 200 starts communication.

It is desirable to enable the RAMNF 100 to know a time after which the terminal device 40 transitions to the idle mode after transitioning to the connected mode once. That is, it is desirable that the RAMNF 100 can know idle transition time information indicating a time until the terminal device 40 transitions from the connected mode to the idle mode.

For example, in a case where the RAMNF 100 cannot know the idle transition time information, the RAMNF 100 needs to acquire the registration information regarding the registration of the terminal device 40 by using the API of the AMF 441 before the client 200 transmits a packet. Here, the registration information includes information indicating the status of the terminal device 40 (for example, whether the terminal device 40 is in the connected mode or the idle mode).

In a case where the terminal device 40 is in the idle mode, the RAMNF 100 needs to perform paging control by using the API of the AMF 441 to cause the terminal device 40 to transition to the connected mode.

An idle transition time is different for each terminal device 40. For example, some of the terminal devices 40 transition to the idle mode in about one second, and some of the terminal devices 40 transition to the idle mode in about six seconds. In such a state where the idle transition time is uncertain, it cannot be said that the RAMNF 100 transmits appropriate information of the network to the client 200.

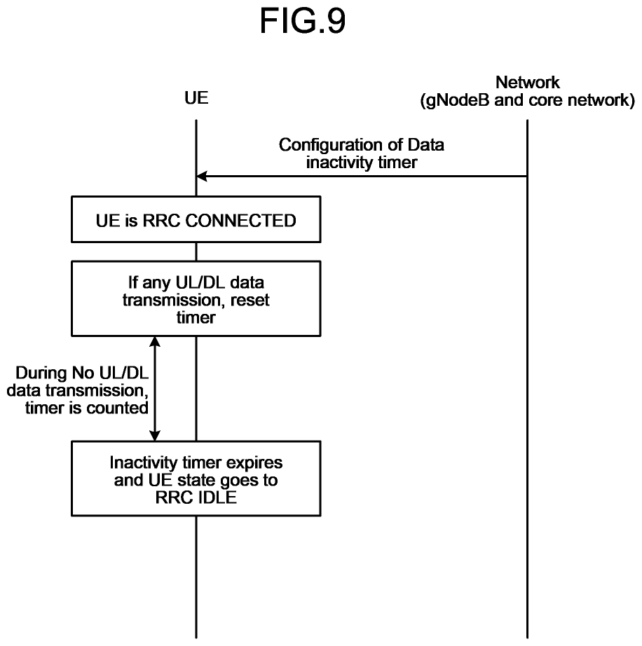

The idle transition time (idle return time) is configured by the base station 20 according to the capability of the terminal device 40. FIG. 9 is a sequence diagram illustrating an example of configuration of the idle transition time by the base station 20. The sequence illustrated in FIG. 9 is described in, for example, Section 5.19 of 3GPP TS38.321 or Section 5.3.9 of TS38.331.

As illustrated in FIG. 9, the base station 20 configures a time during which the terminal device 40 transitions to the idle mode (data inactivity timer) according to the capability of the terminal device 40. From this, it is considered that the idle transition time is a value configured according to both the terminal device 40 and the base station 20. However, it is difficult for the RAMNF 100 to acquire information regarding the configuration performed by the base station 20 (for example, information regarding the data inactivity timer) from all the base stations 20, and it is thus not easy to acquire the idle transition time information.

### 4.2.2. Example of Solution for First Problem

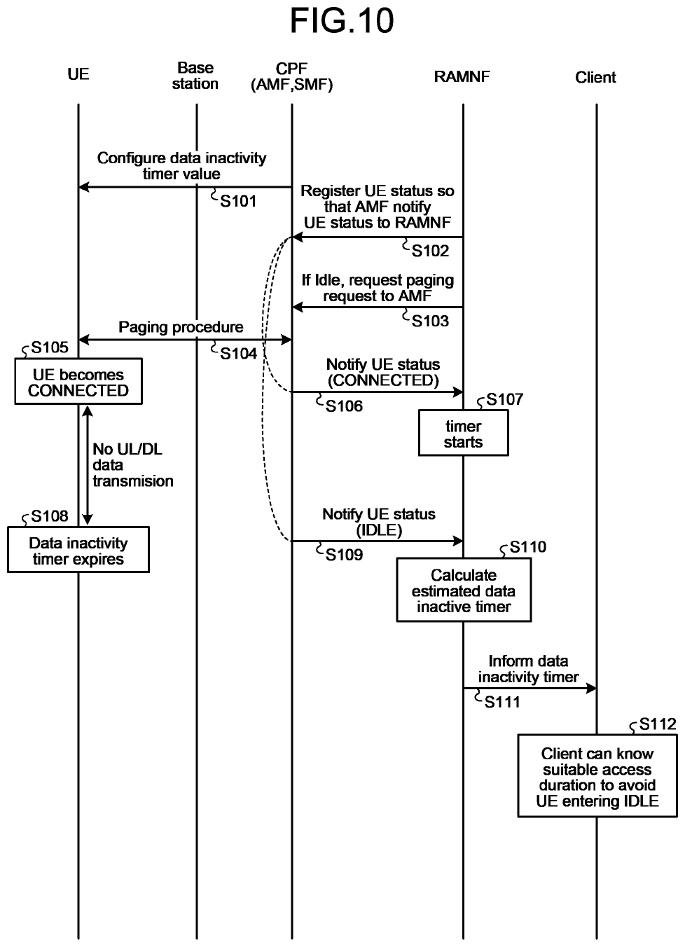

FIG. 10 is a sequence diagram illustrating an example of a flow of first information processing according to a first embodiment of the present disclosure. The first information processing illustrated in FIG. 10 is performed by the information processing system 1.

As illustrated in FIG. 10, the CPF 440 (for example, the AMF 441) on a network side configures a data inactive timer value for the UE 40 (terminal device 40) (Step S101).

The AMF 441 configures the value (data inactive timer value) in consideration of the specification of the UE 40 and the specification of the base station 20. The data inactive timer value is, for example, a value such as one second or six seconds.

In a case where there is no transmission/reception of uplink (UL) or/and downlink (DL) data between the UE 40 and the base station 20 for a period of this value, the UE 40 transitions from the connected mode to the idle mode.

Note that, although the AMF 441 configures the data inactive timer value here, the configuration may be performed by the base station 20.

Next, the RAMNF 100 performs UE status registration for notifying the RAMNF 100 of a status of the UE 40 (UE status) from the AMF 441 to the AMF 441 (Step S102).

The RAMNF 100 registers the UE 40 so that the AMF 441 is notified when there is a change in status of the UE 40, such as when the UE 40 transitions from the connected mode to the idle mode or when the UE transitions from the idle mode to the connected mode. For example, an ID (for example, subscription permanent identifier (SUPI)) of the UE 40 can be used for this registration.

If the UE 40 is in the idle mode, the RAMNF 100 requests the AMF 441 for a paging request (Step S103). The RAMNF 100 requests the AMF 441 to transmit paging to the UE 40 by using the API of the SBI of the AMF 441.

A paging procedure is performed between the AMF 441 of the CPF 440 and the UE 40 (Step S104). Accordingly, the UE 40 becomes connected (Step S105).

The AMF 441 of the CPF 440 notifies the RAMNF 100 of the status of the UE 40 (UE status) (Step S106). Here, the AMF 441 makes a notification that the status of the UE 40 is the connected status. Since the RAMNF 100 has performed the UE status registration with respect to the AMF 441 in Step S102, the AMF 441 notifies the RAMNF 100 of a change in status of the UE 40 (here, transition from the idle mode to the connected mode).

Upon receiving the notification, the RAMNF 100 starts a timer (Step S107). That is, the RAMNF 100 starts time measurement by the timer.

As illustrated in FIG. 10, when the data inactive timer expires with no UL/DL data transmission (Step S108), the UE 40 transitions from the connected mode to the idle mode.

Since both the UE 40 and the AMF 441 have the data inactive timer, the AMF 441 knows that the UE 40 has transitioned to the idle mode. In this case, the AMF 441 notifies the RAMNF 100 of the status of the UE 40 (Step S109).

Here, the AMF 441 notifies that the status of the UE 40 is the Idle status. Since the RAMNF 100 has performed the UE status registration with respect to the AMF 441 in Step S102, the AMF 441 notifies the RAMNF 100 of a change in status of the UE 40 (here, transition from the idle mode to the connected mode).

The RAMNF 100 that has received the notification stops the timer started in Step S107, and calculates the estimated data inactive timer based on a measurement time of the timer (Step S110). For example, the RAMNF 100 estimates the measurement time of the timer as the idle transition time until the UE 40 transitions to the idle status.

In this manner, the RAMNF 100 acquires the first information (here, the registration information regarding the registration (for example, UE status) of the UE 40). The RAMNF 100 calculates information regarding a transition interval of the registration (an example of the measurement time, here, the idle transition time information) based on the acquired first information.

Note that, here, the AMF 441 makes a notification of the UE status based on the UE status registration by the RAMNF 100, but a method by which the RAMNF 100 acquires the UE status is not limited thereto.

For example, the RAMNF 100 may transmit a request for knowing the status of the UE 40 to the AMF 441 periodically (for example, every 0.5 seconds). In this case, the RAMNF 100 calculates the idle transition time information based on the change in status of the UE 40 included in a response from the AMF 441.

The RAMNF 100 notifies the client 200 of the data inactive timer (Step S111). For example, the RAMNF 100 notifies the client 200 of the idle transition time calculated in Step S110 as the data inactive timer.

The client 200 can know a suitable access duration to avoid the UE 40 from entering the Idle mode (Step S112). That is, in a case of continuously transmitting data to the UE 40, if the client 200 transmits the data at an interval shorter than the idle transition time, the data can be transmitted to the UE 40 in the connected mode before the UE 40 transitions to the idle mode.

When the UE 40 enters the idle mode, the client 200 needs to transmit data after, for example, transmitting paging to cause the UE 40 to transition from the idle mode to the connected mode. Therefore, when the UE 40 enters the idle mode, a delay of several 100 ms may occur before the client 200 transmits data.

As described above, the client 200 can transmit data before the UE 40 enters the idle mode by knowing the idle transition time, and can thus further reduce a delay that occurs in data transmission.

Note that, in FIG. 10, the RAMNF 100 measures the data inactive timer by performing the operation one time (an operation from the start to the end of timer measurement), but the number of times the operation is performed may be two times or more. That is, the RAMNF 100 may calculate the idle transition time (for example, an average value) by repeatedly performing the operation from Step S103 to Step S110 (for example, 10 times).

For example, in the UE 40, various applications are operating, and in a case where transmission and reception are required in the application, the UE 40 side returns to the wireless section of the network (transition to the connected mode). Therefore, the RAMNF 100 can calculate a more accurate idle transition time by calculating the idle transition time based on the time measured by repeatedly performing the operation a plurality of times.

Here, a supplementary description of a special case will be provided. It is conceivable that there is a base station 20 that cannot awake the UE 40 by the paging API among the base stations 20. For example, the capability of the small base station 20 and the small core network CN used for the private network may be simplified. In this case, even in a case where the RAMNF 100 activates the paging API of the AMF 441, it is conceivable that the UE 40 does not transition from the idle mode to the connected mode. Therefore, the RAMNF 100 performs confirmation processing of confirming whether or not the status of the UE 40 transitions by paging.

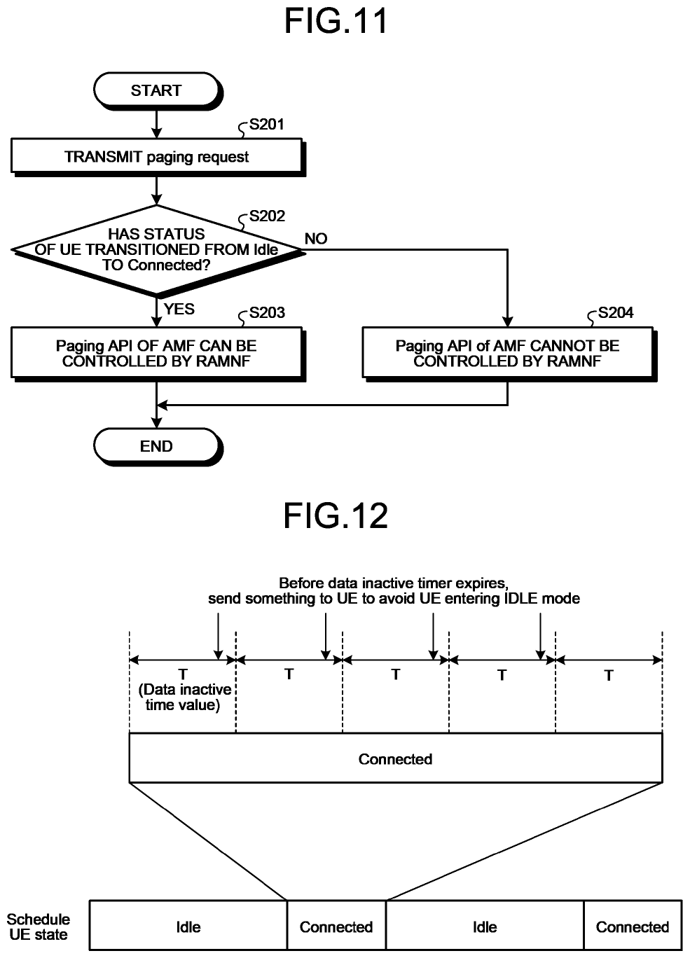

FIG. 11 is a flowchart illustrating an example of a flow of the confirmation processing according to the first embodiment of the present disclosure. The confirmation processing illustrated in FIG. 11 is performed by the RAMNF 100, for example, before the measurement of the idle transition time.

As illustrated in FIG. 11, the RAMNF 100 transmits a paging request to the AMF 441 (Step S201). For example, in a case where the UE 40 is in the idle mode, the RAMNF 100 transmits the paging request to the AMF 441.

Thereafter, the RAMNF 100 determines whether or not the status of the UE 40 has transitioned from the idle mode to the connected mode (Step S202). The RAMNF 100 determines the status of the UE 40 based on the notification from the AMF 441.

In a case where the status of the UE 40 has transitioned from the idle mode to the connected mode (Step S202; Yes), the RAMNF 100 determines that the paging API of the AMF 441 can be controlled by the RAMNF 100 (Step S203), and ends the processing.

On the other hand, in a case where the status of the UE 40 has not transitioned from the idle mode to the connected mode (Step S202; No), the RAMNF 100 determines that the paging API of the AMF 441 cannot be controlled by the RAMNF 100 (Step S204), and ends the processing.

The RAMNF 100 can disclose, to the client 200, the result of the confirmation processing, that is, whether or not the paging API of the AMF 441 can be controlled by the RAMNF 100.

Here, FIG. 12 is a diagram for describing an example of scheduling of the status of the UE 40 by the RAMNF 100 according to the first embodiment of the present disclosure. As described above, the RAMNF 100 calculates the idle transition time. In FIG. 12, the RAMNF 100 calculates (acquires) a time T as the idle transition time (data inactive time value).

The RAMNF 100 transmits something data to the UE 40 to avoid the UE 40 from entering the idle mode before the data inactive timer expires. As a result, the RAMNF 100 can control the status of the UE 40. In the example of FIG. 12, the RAMNF 100 schedules the status of the UE 40 in such a way that the UE 40 repeatedly switches between the idle mode and the connected mode at predetermined intervals. The RAMNF 100 notifies the client 200 of the schedule of the status of the UE 40.

As described above, the RAMNF 100 communicates with the UE 40 before a timing at which the UE 40 transitions to the idle status based on the idle transition time (an example of the measurement information). As a result, the RAMNF 100 controls a time during which the UE 40 is in the idle mode and a time during which the UE is in the connected mode in a planned manner. In addition, the RAMNF 100 notifies the client 200 of a schedule (plan) of the registration (idle/connected) of the UE 40.

The client 200 can access the UE 40 in a case where the UE 40 is in the connected mode by using the notified schedule from the RAMNF 100. As a result, the client 200 can access the UE 40 with a lower delay.

As described above, the RAMNF 100 can prevent the UE 40 from transitioning to the idle mode by transmitting a signal from the network side before the UE 40 transitions to the idle mode, and can control the registration status of the UE 40. Note that the signal transmitted from the network side at this time may be any signal or a signal having a small data amount. In this way, as the network side transmits a small signal, an increase in network traffic can be suppressed.

Note that the RAMNF 100 may be defined as a new network function (NF) of the core network CN, and the function of the RAMNF 100 may be implemented as a new function in the existing AMF 441, SMF 442, and location management function (LMF).

As described above, the RAMNF 100 can acquire the idle transition time of the UE 40 that is the information of the network, and can provide the idle transition time to the client 200.

As a result, the client 200 can know how long the signal need to be continuously transmitted to the UE 40 so that the UE 40 can continue the communication without transitioning to the idle mode. The client 200 can continue to transmit the signal so that the UE 40 does not transition to the idle mode, which can achieve lower-delay communication.

The RAMNF 100 notifies the client 200 of the schedule of idle/connected status of the UE 40. At this time, by acquiring the idle transition time, the RAMNF 100 can reduce the number of times the paging control necessary for keeping the schedule is performed and the number of times of awaking the UE 40 by transmitting data. That is, the RAMNF 100 can keep the schedule of idle/connected status of the UE 40 by minimum paging control and data transmission based on the idle transition time.

As a result, the RAMNF 100 can save communication resources of the UE 40 and the core network CN and computer resources. In particular, the RAMNF 100 can suppress power consumption of the UE 40. As described above, the RAMNF 100 can efficiently manage the schedule of the registration (idle/connected) of the UE 40.

### 4.3. Second Embodiment

### 4.3.1. Second Problem

It is desirable that the RAMNF 100 can correctly provide, to the client 200, information grasped by the application layer of the UE 40 among the pieces of information regarding the status of the network of the UE 40. In addition, it is desirable that the RAMNF 100 can provide the information to the client 200 in cooperation with other network information (for example, the first information obtained via the SBI).

As described above, the RAMNF 100 can acquire the information regarding the network of the UE 40 to some extent via the AMF 441 of the core network CN or the API of the SBI of the SMF 442.

The information regarding the network of the UE 40 (first information) acquired in this manner includes, for example, information indicating whether the UE 40 is in the idle mode or the connected mode, information indicating whether the UE 40 is registered or de-registered, and the like.

It is desirable that the RAMNF 100 can acquire information regarding behavior that cannot be known unless it is the application layer of the UE 40 (hereinafter, also described as the terminal-related information).

The terminal-related information includes, for example, at least one of the schedule information regarding the schedule of the registration (registered/de-registered), the power information regarding the power consumption of the UE 40, or the location information regarding the location of the UE 40. Note that the location information here is not location information of the UE 40 estimated from a reference signal of 5G, but high-accuracy location information using wireless information of the GPS, wireless LAN, or Bluetooth (registered trademark).

In addition, it is desirable that the RAMNF 100 can provide the acquired terminal-related information to the client 200. At this time, it is further desirable that the RAMNF 100 can combine the first information (network information) acquired via the AMF 441 or the SMF 442 and the terminal-related information known by the application layer and provide the pieces of information to the client 200 as one piece of information.

As the RAMNF 100 combines the first information and the terminal-related information and provides the first information and the terminal-related information as one piece of information to the client 200, the service and the network can be combined, and a valuable new service can be provided. Therefore, it is required to provide such information obtained by combining the first information and the terminal-related information.

### 4.3.2. Example of Solution for Second Problem

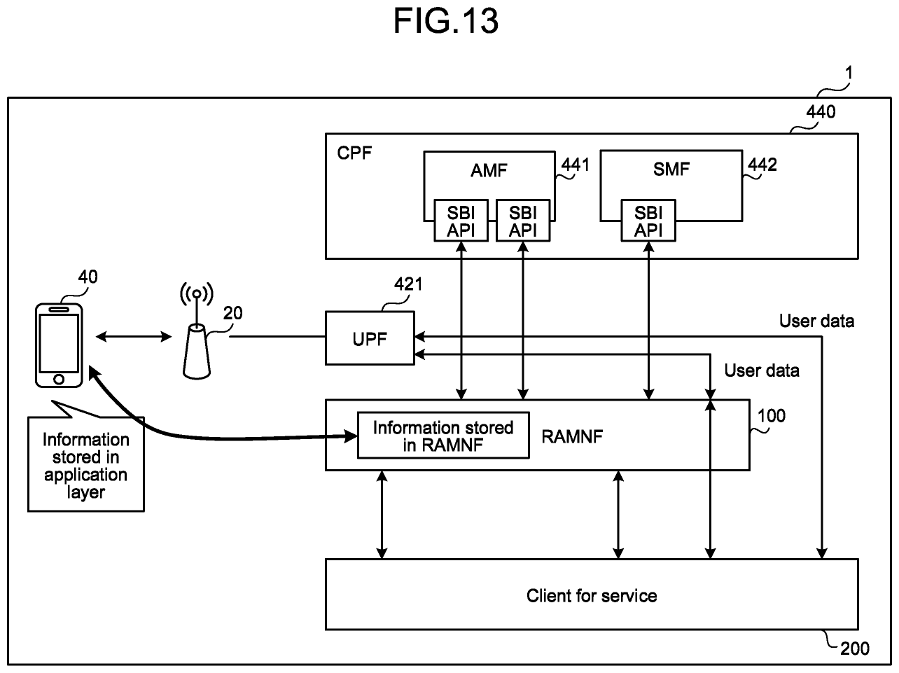

FIG. 13 is a diagram illustrating an example of an information processing system 1 according to a second embodiment of the present disclosure. The information processing system 1 illustrated in FIG. 13 is the same as the information processing system 1 illustrated in FIG. 8 except that the terminal-related information is transmitted and received between the RAMNF 100 and the UE 40.

In the information processing system 1 illustrated in FIG. 13, the RAMNF 100 is notified of information (terminal-related information) stored in the application layer of the UE 40, and similar information is also stored in the RAMNF 100.

The terminal-related information includes, for example, at least one of the schedule information regarding a registration schedule, the power information regarding the power consumption of the UE 40, or the location information regarding the location of the UE 40. Hereinafter, details of an example of the terminal-related information will be described.

### (Registration (Registered/De-Registered) Schedule Information)

Detachment of the UE 40 means that the UE 40 is completely separated from the network, and at that time, the IP address assigned to the UE 40 by the SMF 442 of the core network CN becomes invalid. On the other hand, when the UE 40 is attached to the network, the SMF 442 assigns the IP address to the UE 40.

Then, when the UE 40 transitions from the idle mode to the connected mode, the wireless section is connected, and the UE 40 can perform communication. That is, the UE needs to be in the registered status in order for the UE 40 to be connected.

In a case where the UE 40 is registered and is in the idle status, the IP address is assigned to the UE 40, but the UE 40 cannot perform communication. In a case where the UE 40 is de-registered, since the IP address is not assigned to the UE 40, the UE 40 is in a state in which communication completely cannot be performed.

Here, in a case where the UE 40 is a low power consumption device such as a case where the UE 40 is an IoT device, it is conceivable that the UE 40 is in the registered status only when necessary for battery saving. That is, it is conceivable that the UE 40 performs a plan (schedule) in which the registered status and the de-registered status are repeated at a constant cycle on the application layer. In this case, the UE 40 repeats attachment and detachment, that is, the registered status and the de-registered status according to the schedule.

The RAMNF 100 can provide the schedule information to the client 200 by grasping the cycle as the schedule information.

Hitherto, it has not been assumed that application-level information such as the schedule information is transmitted and received between an application installed in a client server (client 200) and an application installed in the UE 40.

As described above, the RAMNF 100 is a platform that mediates between the network and the service. In the present embodiment, the application-level information is provided to the client 200 via the RAMNF 100. The RAMNF 100 can provide, to the client 200, the application-level information together with other information of the network.

### (Power Information)

The RAMNF 100 can provide, to the client 200, the power information regarding a battery of the UE 40 in addition to the schedule information as the terminal-related information (terminal application information) of the UE 40. This is because the power information of the UE 40 affects the schedule information of the connected/idle status of the UE 40 and the information of the registered/de-registered status (for example, the schedule information).

Hereinafter, the connected/idle schedule information is also referred to as connection schedule information. The registered/de-registered schedule information is also described as registration schedule information. In a case where the connection schedule information and the registration schedule information are not distinguished from each other, the connection schedule information and the registration schedule information are simply described as schedule information (the schedule information regarding the registration schedule).

As described above, the schedule regarding registration of the UE 40 affects the power consumption of the UE 40. The RAMNF 100 can not only receive the power information from the UE 40 but also request a registration schedule based on the power information. As described above, when the RAMNF 100 makes the registration schedule request, the RAMNF 100 (or the client 200) can access the UE 40 in more detailed consideration of care for the power consumption of the UE 40. In this manner, the power information can be used for controlling the schedule and accessing the UE 40.

### (Location Information)

Examples of other information included in the terminal-related information include the location information regarding the location of the UE 40. The UE 40 can provide the location information to the client 200 or the like via the RAMNF 100.

In 5G, the AMF 441 can acquire information regarding the location of the UE 40. The AMF 441 can provide the acquired information to other NFs or the like by using the API. However, the location information of the UE 40 handled by the AMF 441 is location information acquired using a positioning technology of 3GPP (registered trademark). The location information is, for example, information estimated based on information such as an estimated arrival time of radio waves from the base station 20 and an estimated arrival direction of the radio waves.

As described above, the location information that can be provided by the AMF 441 is location information obtained by the 3GPP technology.

On the other hand, the location information acquired by the RAMNF 100 from the UE 40 is location information measured by the GPS of the application layer of the UE 40 or location information acquired using radio waves of Bluetooth (registered trademark) or Wi-Fi (registered trademark). That is, the location information is information measured using equipment mounted on the UE 40. The location information is location information that is not collected by the AMF 441. The location information that the AMF 441 does not grasp may be more accurate than the location information collected by the AMF 441.

Hereinafter, the location information that can be provided by the AMF 441 may be referred to as cellular location information, and the location information acquired by the RAMNF 100 from the UE 40 may be referred to as terminal location information to distinguish these pieces of location information.

As described above, the RAMNF 100 acquires various pieces of terminal-related information with high accuracy from the UE 40. The terminal-related information may be related to the first information collected by the RAMNF 100 via the conventional SBI. For example, the terminal location information included in the terminal-related information and the information regarding the registered/de-registered status obtained from the AMF 441.

When the UE 40 reaches a certain location, the status may change from the deregistered status to the registered status. For example, it is assumed that an automatic conveyance robot moving in a factory carries a part to a predetermined location and arrives at a predetermined location. For example, once the automatic conveyance robot arrives at the predetermined location, the automatic conveyance robot is attached to the network and is registered, and thus can perform communication.

Since the client 200 knows in advance the information that the automatic conveyance robot is registered when arriving at the predetermined location, for example, it is possible to set up a system on the premise that communication becomes possible when the automatic conveyance robot is located at a specific location.

Note that the terminal-related information is not limited to the registration schedule information, the power information, and the location information described above. The terminal-related information may include, for example, the following information.
Whether or not data exists in a monitoring camera
Whether or not a failure has been detected at a factory
Whether or not a conveyance robot of a factory has entered a specific area
Whether or not a drone has entered a specific area
Whether or not a moving speed or speed of a drone has reached a certain value or whether the speed has become a certain value or less
Whether or not a drone has detected another drone
Whether or not an automatic conveyance robot has stopped for collision avoidance
Detection of earthquake and fire
Whether or not a specific session of an application has started
An expected duration of an application

Such terminal-related information regarding various applications can also be collected by the RAMNF 100. The RAMNF 100 can collect these pieces of terminal-related information and notify the client 200 of the terminal-related information in combination with the first information included in the RAMNF 100.

As described above, the RAMNF 100 according to the present embodiment acquires, from the UE 40, information (terminal-related information) that the normal core network CN does not grasp, and provides the information to the client 200 together with the first information acquired via the SBI.

Hereinafter, an example of information provision processing performed by the RAMNF 100 for each piece of terminal-related information will be described.

### (Registration Schedule Information Provision Processing)

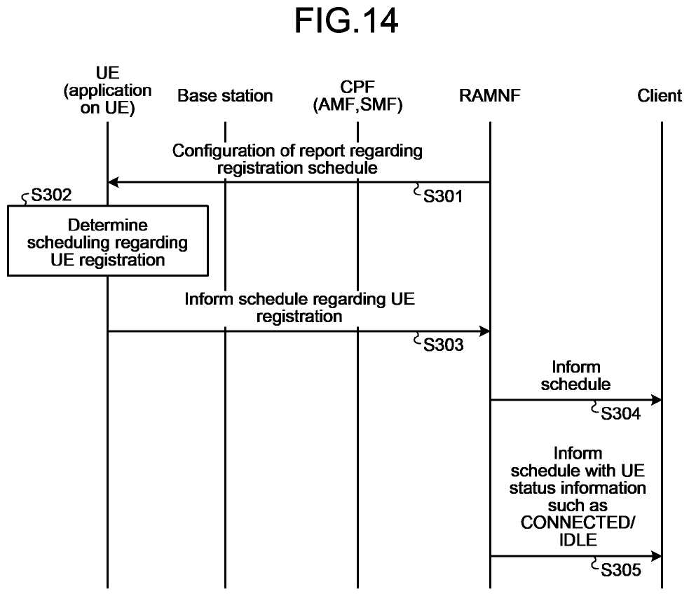

FIG. 14 is a sequence diagram illustrating an example of a flow of registration schedule information provision processing according to the second embodiment of the present disclosure. Note that the UE 40 that performs a part of the provision processing may be the application of the UE 40.

As illustrated in FIG. 14, the RAMNF 100 notifies the UE 40 of configuration of a report of the registration schedule (registration schedule information) (Step S301).

The UE 40 determines the schedule regarding the registration of the UE 40 (Step S302), and notifies the RAMNF 100 of the schedule regarding the registration (Step S303).

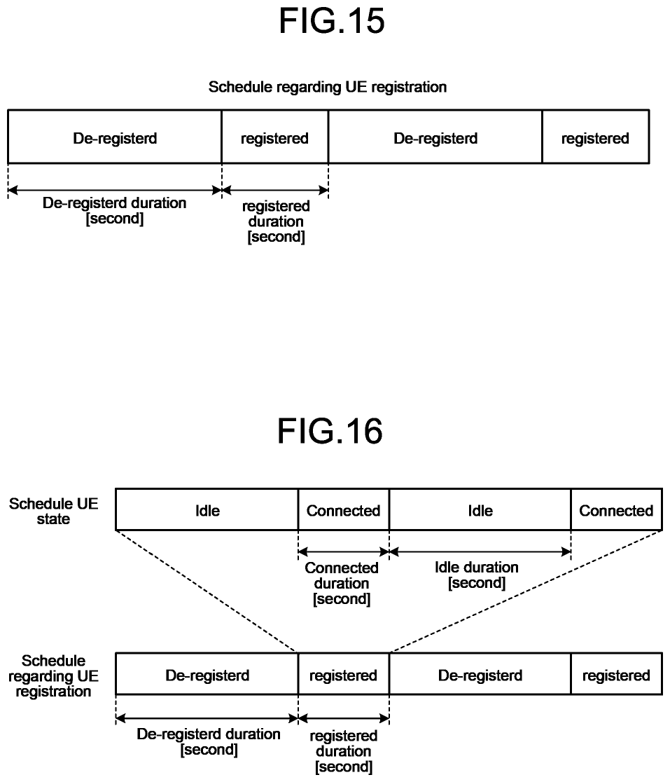

Here, FIG. 15 is a diagram illustrating an example of the registration schedule according to the second embodiment of the present disclosure. As illustrated in FIG. 15, the UE 40 notifies the RAMNF 100 of the registration schedule information including a de-registered duration (second) and a registered duration (second).

Note that FIG. 15 illustrates the registration schedule in which a certain de-registered duration (second) and a certain registered duration (second) are alternately repeated, but the registration schedule is not limited thereto. For example, the RAMNF 100 may be notified of a registration schedule having different de-registered durations (second) and/or registered durations (second) each time.

The description returns to FIG. 14. The RAMNF 100 informs the client 200 of a schedule (Step S304). This schedule may be, for example, the registration schedule acquired by the RAMNF 100 from the UE 40 in Step S303.

In addition, the RAMNF 100 informs the client 200 of a schedule including the status information of the UE 40 such as the connected/idle status (Step S305). This schedule may be the schedule information regarding the registration including the registered/de-registered status and the connected/idle status of the UE 40.

Here, FIG. 16 is a diagram illustrating an example of the schedule regarding the registration according to the second embodiment of the present disclosure. As illustrated in FIG. 16, the RAMNF 100 notifies the RAMNF 100 of the schedule information including the de-registered duration (second) and the registered duration (second). At this time, the RAMNF 100 makes a notification of the schedule information including the information regarding a connected duration (second) and an idle duration (second) in the registered status.

In this manner, the RAMNF 100 integrates the registration schedule information and the connection schedule information, and notifies the client 200 of the integrated information as one piece of schedule information.

As described above, as the UE 40 accesses the RAMNF 100, the registration schedule information of the UE 40 is transmitted (shared) between the application of the UE 40 and the application of the RAMNF 100.

As a member of the NF of the core network CN, the RAMNF 100 provides information to the client 200 by combining the terminal-related information regarding the application of the UE 40 and the first information regarding the status of the network.

In a case where there is a change in registration schedule, the UE 40 accesses the RAMNF 100 and notifies the RAMNF 100 that there is a change.

Here, the registration schedule information of the UE 40 is the terminal-related information known (managed) by the application of the UE 40. The connection schedule information of the UE 40 is information that can be controlled by the RAMNF 100, that is, information that can be created by the RAMNF 100. The RAMNF 100 can provide, to the client 200, the registration schedule information and the connection schedule information by acquiring the registration schedule information of the UE 40.

That is, the client 200 can grasp at which time the UE 40 is registered and at which time the UE is connected in the registered duration. Therefore, the client 200 can access the UE 40 while the UE 40 is in the connected status.

In a case where the client 200 inadvertently accesses the UE 40, there is a possibility that the UE 40 is de-registered and the IP address is not assigned to the UE 40. Alternatively, in a case where the client 200 accesses the UE 40 when the UE 40 is in the idle status, the paging message is sent to the UE 40, and there is a possibility that the power consumption of the UE 40 increases.

The power consumption of the UE 40 can be suppressed by the client 200 accessing the UE 40 at a connected time of the UE 40 determined in advance based on the schedule information.

Note that the RAMNF 100 may notify the client 200 of a time during which the UE 40 is RRC connected (connection schedule information) alone as the registration schedule information provision processing. For example, the RAMNF 100 may notify the client 200 of the connection schedule information and the registration schedule information. Also in this case, the connection schedule information and the registration schedule information are notified in association with each other, so that the client 200 can use the registration schedule information and the connection schedule information provided from the UE 40 as integrated schedule information.

As described above, also in a case where the RAMNF 100 makes a notification of each of the connection schedule information and the registration schedule information, it can be said that the connection schedule information and the registration schedule information are notified in association with each other, so that these pieces of information are integrated (combined) and notified.

As described above, the RAMNF 100 combines the connection schedule information and the registration schedule information and provides the combined information as the integrated schedule information of the UE 40 to the client 200. As a result, the client 200 can know in advance at which time access to the UE 40 is to be made to communicate with the UE 40.

In a case where the UE 40 is an IoT device, it is conceivable that the number of UEs 40 accessed by the client 200 increases. In addition, it is conceivable that a number of clients 200 for services access one UE 40. As described above, even in a case where there is a possibility that many communications occur between the client 200 and the UE 40, the client 200 can access the UE 40 that is in the connected status, so that it is possible to reduce useless communications with the UE 40. As a result, low power consumption of the network and/or the UE 40 is achieved.

Note that, in the second embodiment of the present disclosure, communication between the UE 40 and the RAMNF 100 can be directly performed between the UE 40 and the RAMNF 100 via the base station 20. Alternatively, the RAMNF 100 may communicate with the UE 40 via the SBI by another NF of the core network such as the AMF 441. As described above, a communication path of the RAMNF 100 and the UE 40 is not particularly limited. The same applies to other embodiments.

### (Power Information Provision Processing)

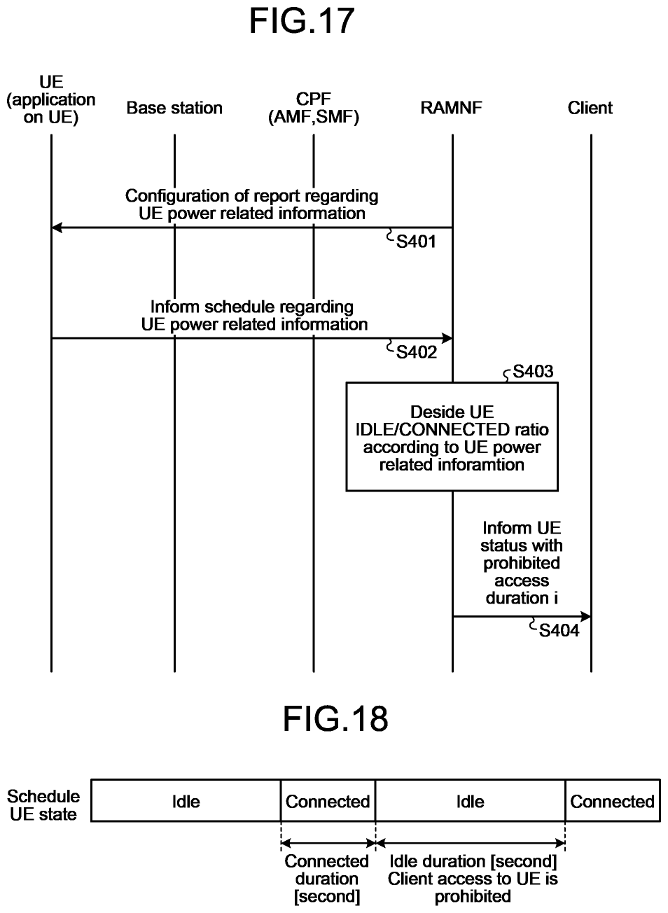

FIG. 17 is a sequence diagram illustrating an example of a flow of power information provision processing according to the second embodiment of the present disclosure. Note that the UE 40 that performs a part of the provision processing may be the application of the UE 40.

As illustrated in FIG. 17, the RAMNF 100 notifies the UE 40 of configuration of a report of UE power related information (power information) (Step S401). The UE 40 informs the RAMNF 100 of the UE power related information of the UE 40 (Step S402).

The RAMNF 100 decides a connected/idle ratio of the UE 40 according to the UE power related information (Step S403). The RAMNF 100 informs the client 200 of the UE status including a prohibited access duration i based on the decided connected/idle ratio, for example (Step S404).

Here, FIG. 18 is a diagram illustrating an example of the connection schedule according to the second embodiment of the present disclosure. As illustrated in FIG. 18, the UE 40 notifies the RAMNF 100 of the connection schedule information (a schedule UE state) including the connected duration (second) and the idle duration (second).

In this manner, the RAMNF 100 makes a notification of the connection schedule information illustrated in FIG. 18 as the UE status, for example. In this case, in the idle duration, the client 200 is prohibited from accessing the UE 40. That is, the idle duration corresponds to the prohibited access duration i.

As described above, in the power information provision processing, the power information of the UE 40 is transmitted (shared) between the application of the UE 40 and the application of the RAMNF 100 by accessing the RAMNF 100 from the UE 40.

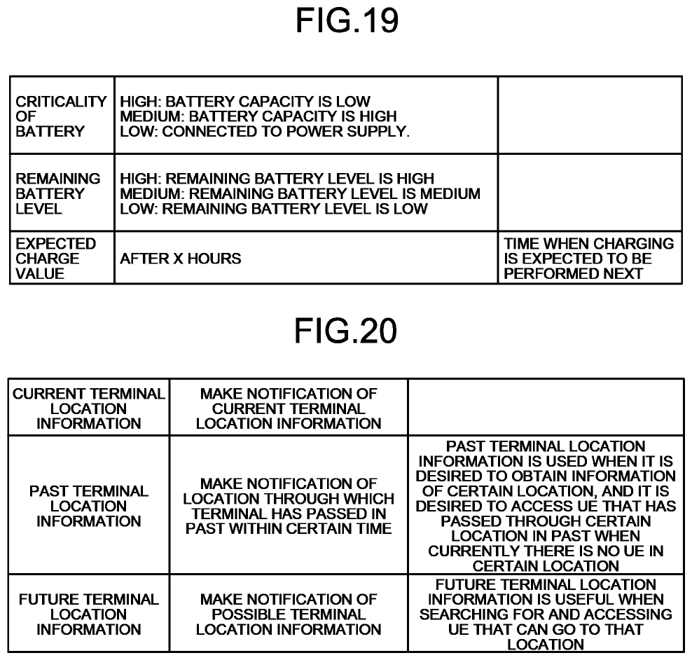

Here, FIG. 19 is a table illustrating the power information according to the second embodiment of the present disclosure. As illustrated in FIG. 19, the power information can include a criticality of the battery, a remaining battery level, an expected charge value, and the like.

The criticality of the battery is information indicating the capacity of the battery. For example, in a case where the battery capacity is low, the criticality of the battery is “high”, and in a case where the battery capacity is high, the criticality of the battery is “medium”. In addition, in a case where the UE 40 is connected to a power supply, the criticality of the battery is “low” regardless of the battery capacity.

The remaining battery level is information indicating the remaining battery level. The expected charge value is information indicating a time when charging is expected to be performed next, and can be represented by, for example, a time when charging is performed, such as after X hours. The expected charge value can be determined by the UE 40 based on, for example, a previous charge time, a charge cycle, or the like.

Here, it is assumed that the criticality of the battery and the remaining battery level are expressed in three stages of “high”, “medium”, and “low”, but the representation of the criticality of the battery and the remaining battery level is not limited thereto. For example, the criticality of the battery and the remaining battery level may be expressed in two stages of “high” and “low”, or may be expressed in four or more stages. Further, the criticality of the battery and the remaining battery level may be represented by a numerical value or a ratio such as a percentage.

For example, the RAMNF 100 that has acquired such power information provides, to the client 200, the terminal-related information (for example, power information) of the UE 40 and the first information (for example, the registration information) regarding the status of the network together as a member of the NF of the core network CN.

When there is a change in power information such as when there is a large change in remaining battery level, the UE 40 accesses the RAMNF 100 and makes a notification of the latest power information.

As described above, the RAMNF 100 acquires information managed by the application layer of the UE 40, such as the power information. As a result, the RAMNF 100 can decide the connected/idle ratio according to the power information. Furthermore, the RAMNF 100 can decide the prohibited access duration of the UE 40 based on the decided ratio, and provide the connection schedule information including the prohibited access duration to the client 200.

The client 200 can access the UE 40 while avoiding the prohibited access duration (for example, the idle duration), and can implement low power consumption of the UE 40. For example, the client determines a UE 40 to access based on the terminal-related information (for example, power information) of the UE 40 and the first information (for example, the registration information) regarding the status of the network. As a result, the client 200 can access a UE 40 while avoiding the UE 40 with a low remaining battery level, for example.

### (Terminal Location Information Provision Processing)

The RAMNF 100 collects terminal location information of the UE 40. At this time, the RAMNF 100 can collect at least one of current terminal location information, past terminal location information, or and future terminal location information.

FIG. 20 is a table illustrating an example of the terminal location information according to the second embodiment of the present disclosure. As illustrated in FIG. 20, the RAMNF 100 collects, for example, the current terminal location information, the past terminal location information, and the future terminal location information.

The current terminal location information is information regarding a current terminal location. The RAMNF 100 collects the current terminal location information and notifies the client 200 of the terminal location information.

The past terminal location information is information indicating a location through which the UE 40 has passed within a certain time in the past. The RAMNF 100 collects the past terminal location information and notifies the client 200 of the terminal location information. At this time, the RAMNF 100 can makes a notification of the past terminal location information as group information. The group information is described in detail in a third embodiment.

For example, it is assumed that the client 200 desires to acquire information of a certain location. At this time, when there is no UE 40 located at the location at the current time, the client 200 can acquire the information of the location by accessing the UE 40 that was located at the location in the past. In this way, the past terminal location information is used when the client 200 desires to access the UE 40 that has passed through a specific location in the past.

The future terminal location information is information indicating a possible location where the UE 40 may go. The RAMNF 100 collects the future terminal location information and notifies the client 200 of the terminal location information.

The future terminal location information is information useful when the client 200 searches for and accesses a UE 40 that can go to that location (for example, a specific location).

As described above, the RAMNF 100 according to the present embodiment separately collects the past terminal location information, the current terminal location information, and the future terminal location information and notifies the client 200 of the pieces of terminal location information. Hereinafter, an example of processing of providing each of the past terminal location information, the current terminal location information, and the future terminal location information will be described.

### (Current Terminal Location Information Provision Processing)

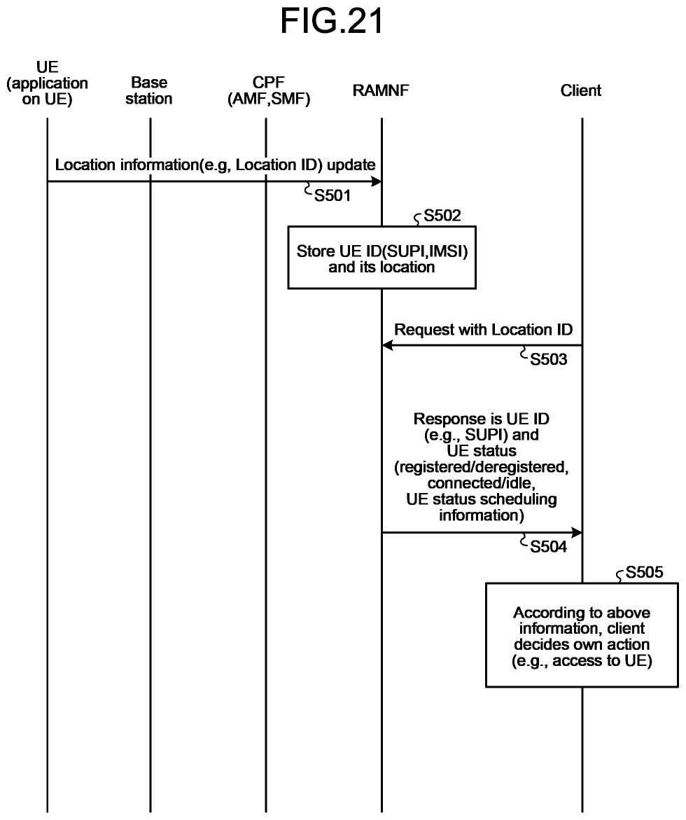

FIG. 21 is a sequence diagram illustrating an example of a flow of the current terminal location information provision processing according to the second embodiment of the present disclosure. Note that the UE 40 that performs a part of the provision processing may be the application of the UE 40.

The UE 40 updates the terminal location information (location information) represented by, for example, a location ID (Step S501). The UE 40 updates the terminal location information by notifying the RAMNF 100 of the current terminal location information.

The RAMNF 100 stores the ID (for example, SUPI or international mobile subscriber identity (IMSI)) of the UE 40 and the location of the UE 40 (Step S502). The RAMNF 100 stores the ID of the UE 40 and the terminal location information acquired in Step S501 in association with each other.

Next, upon receiving a request including the location ID from the client 200 (Step S503), the RAMNF 100 responds to the client 200 with the ID of the UE 40 (for example, SUPI) and the UE status of the UE 40 (Step S504). That is, the RAMNF 100 responds to the client 200 by associating the ID of the UE 40 located in an area corresponding to the location ID with the status of the UE 40. The UE status includes, for example, information indicating whether the UE 40 is registered or deregistered and whether the UE 40 is in the connected status or the idle status, and UE status schedule information.

The client 200 determines its own action such as accessing the UE 40 according to the above-described information (information in which the ID and the status of the UE 40 are associated with each other) (Step S505).

In this way, the current terminal location information is useful for the client 200 that desires to access the UE 40 at a specific location. The RAMNF 100 notifies the client 200 of the registered UE 40 that is located in a specific area designated by the client 200, for example.

In this way, the RAMNF 100 may provide information to the client 200 by combining the current terminal location information and the first information regarding the network. The client 200 can know whether or not the UE 40 in a specific area is accessible. That is, the client 200 can acquire information regarding an accessible UE 40 in a specific area.

This specific area is, for example, a mesh-like area of 10 m square. In this manner, it is assumed that a resolution of the area is determined in advance.

When the UE 40 moves to a location, the UE 40 notifies (updates) the RAMNF 100 that the UE 40 has transitioned to the registered status and the connected status and has moved to the location. After the notification, the UE 40 may transition to the idle status.

In this manner, the UE 40 registers the current terminal location information in the RAMNF 100.

The registration of the terminal location information here is different from a conventional tracking update in that the terminal location information is updated based on the terminal location information of the application layer of the UE 40. An area targeted by the conventional tracking update is an area bound by a plurality of base stations 20 and is a very large area compared to an area targeted by terminal location information. In addition, the conventional tracking update is performed using a 5G radio technology.

On the other hand, the registration of the terminal location information according to the present embodiment is updated based on the terminal location information of the application layer of the UE 40 as described above. As described above, the terminal location information is information targeted for a narrow area such as 10 m square.

Furthermore, in the present embodiment, the RAMNF 100 acquires the terminal location information from the UE 40 directly or via the SBI. In this respect, the tracking update is different from a tracking update that acquires the location information from the core network CN.

As described above, the client 200 makes an inquiry about the UE 40 in a specific location (area) to the RAMNF 100. At this time, the client 200 can designate the specific location by using the location ID.

The RAMNF 100 can respond to the client 200 by associating the ID (the IMSI, the SUPI, or the like) of the UE 40 in the area corresponding to the location ID with the UE status (for example, whether or not the UE 40 is registered). At this time, the RAMNF 100 may transmit, to the client 200, a response including the connection schedule information and the registration schedule information described in the first embodiment.

In addition, in a case where a plurality of UEs 40 exist in the area corresponding to the location ID, the RAMNF 100 may respond to the client 200 with the plurality of UEs 40 as the group information. The group information is described in detail in a third embodiment.

### (Past Terminal Location Information Provision Processing)

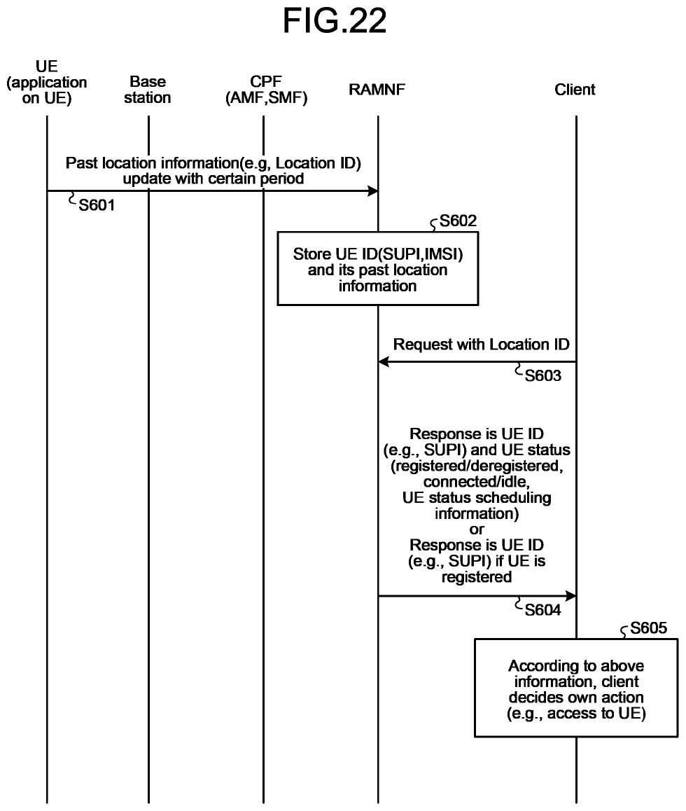

FIG. 22 is a sequence diagram illustrating an example of a flow of past terminal location information provision processing according to the second embodiment of the present disclosure. Note that the UE 40 that performs a part of the provision processing may be the application of the UE 40.

The UE 40 updates the past terminal location information (location information) represented by, for example, a location ID or the like with a certain period (Step S601). The UE 40 updates the past terminal location information by notifying the RAMNF 100 of the past terminal location information together with the period.

The RAMNF 100 stores the ID (for example, SUPI or international mobile subscriber identity (IMSI)) of the UE 40 and the past location information of the UE 40 (Step S602). The RAMNF 100 stores the ID of the UE 40 and the past terminal location information acquired in Step S501 in association with each other.

Next, the RAMNF 100 receives a request including a location ID from the client 200 (Step S603). The RAMNF 100 responds to the client 200 with the ID (for example, SUPI) of the UE 40 and the UE status of the UE 40, or responds to the client 200 with the ID (for example, SUPI) of the UE 40 in a case where the UE 40 is registered (Step S604).

That is, the RAMNF 100 responds to the client 200 by associating the ID of the UE 40 that stayed in the area corresponding to the location ID in the past with the status (UE status) of the UE 40. Alternatively, the RAMNF 100 responds to the client 200 with the ID of the UE 40 that stayed in the area corresponding to the location ID for a predetermined period in the past among the registered UEs 40. The UE status includes, for example, information indicating whether the UE 40 is registered or deregistered and whether the UE 40 is in the connected status or the idle status, and UE status schedule information.

The client 200 decides its own action such as accessing the UE 40 according to the above information (information in which the ID and the status of the UE 40 are associated with each other) (Step S605).

In this manner, the past terminal location information is useful for the client 200 that desires to access the UE 40 that was in a specific location in the past. The number of specific locations may be plural, and the specific location may also be a trajectory.

For example, it is assumed that, while staying (or moving) in a specific location, the UE 40 accumulates area information depending on the location such as a temperature and humidity of the location (area). The past terminal location information is useful, for example, for the client 200 that desires to acquire the area information.

In this manner, the RAMNF 100 can provide information to the client 200 by combining the past terminal location information and the first information regarding the network. The client 200 can know whether or not a UE 40 that was in a specific area in the past is accessible (registered or/and connected). That is, the client 200 can acquire information regarding an accessible (registered or/and connected) UE 40 that was in a specific area.

For example, the UE 40 notifies the RAMNF 100 of information regarding a location where the UE 40 stayed (has passed) as the past terminal location information at a constant cycle, for example, every day or every several hours. The RAMNF 100 accumulates the past terminal location information together with the ID of the UE 40.

The client 200 inquires of the RAMNF 100 about information of a UE 40 that has passed through a specific location.

For example, the RAMNF 100 transmits a response by associating information (the ID of the UE 40) identifying the UE 40 that has passed through the specific location and the status (UE status) of the UE 40 with each other.

Alternatively, for example, the RAMNF 100 may respond to the client 200 with information of a UE 40 that is currently registered from among UEs 40 that have passed through the specific location. As a result, the client 200 can access the UE 40 that has passed through the specific location and acquire the area information.

Alternatively, when the UE 40 that has passed through the specific location is registered, the client 200 may register with the RAMNF 100 so that the client 200 is notified of the information regarding the UE 40.

In this case, when detecting that the UE 40 that has passed through the specific location is registered, the RAMNF 100 notifies the client 200 of the information regarding the UE 40. Alternatively, the RAMNF 100 may make a notification to the client 200 when the UE 40 that has passed through the specific location is registered and connected.

The area of the past terminal location information may be the same as or different from that of the current terminal location information. It is sufficient if the target area of the past terminal location information is an area narrower (with higher accuracy) than the area of the location information acquirable from the network side.

### (Future Terminal Location Information Provision Processing)

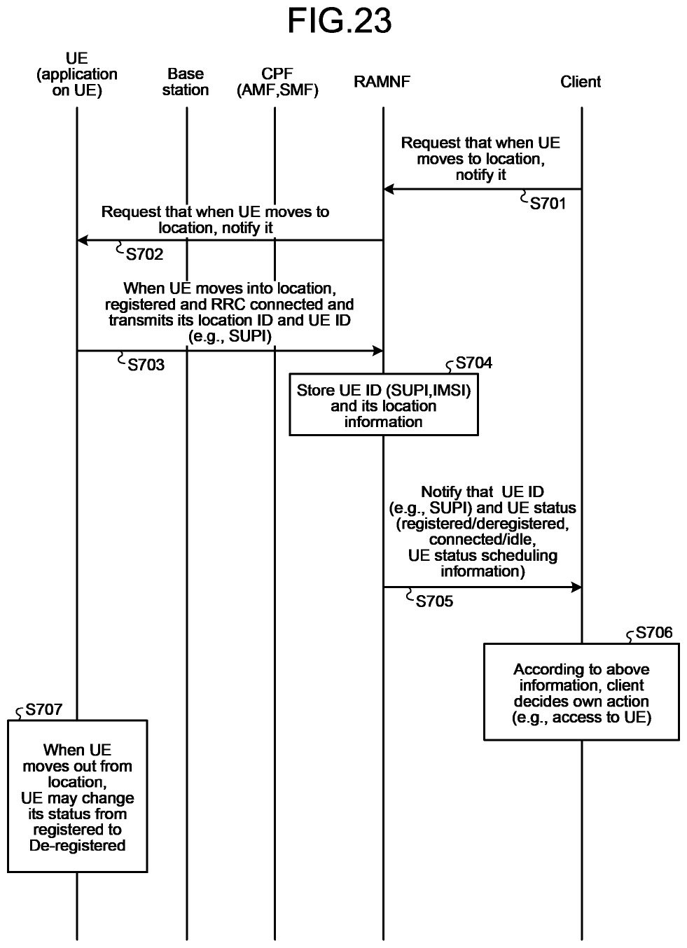

FIG. 23 is a sequence diagram illustrating an example of a flow of future terminal location information provision processing according to the second embodiment of the present disclosure. Note that the UE 40 that performs a part of the provision processing may be the application of the UE 40.

As illustrated in FIG. 23, in a case where the UE 40 has moved to a certain location, the client 200 requests the RAMNF 100 to make a notification of the fact (Step S701).

In a case where the UE 40 has moved to a certain location, the RAMNF 100 requests the UE 40 to make a notification of the fact (Step S702).

When the UE 40 has moved to the location designated by the request, the UE 40 is registered and RRC connected and transmits the location ID and the UE ID (for example, SUPI) to the RAMNF 100 (Step S703).

The RAMNF 100 stores the ID (for example, SUPI or international mobile subscriber identity (IMSI)) of the UE 40 and the location information of the UE 40 (Step S704).

The RAMNF 100 notifies the client 200 of the ID (for example, SUPI) of the UE 40 and the UE status of the UE 40 (Step S705). The UE status includes, for example, information indicating whether the UE 40 is registered or deregistered and whether the UE 40 is in the connected status or the idle status, and UE status schedule information.

The client 200 decides its own action such as accessing the UE 40 according to the above information (information in which the ID and the status of the UE 40 are associated with each other) (Step S706).

Furthermore, in a case where the UE has moved out from the location designated in the request, the UE 40 can change its own status from the registered status to the deregistered status (Step S707).

As described above, the future terminal location information is information indicating that the UE 40 is likely to move to a specific location in the future. The client 200 makes a request the UE 40 via the RAMNF 100 in such a way that the UE 40 is registered when the UE 40 arrives at the location.

In addition, the client 200 registers with the RAMNF 100 in such a way as to be notified when the UE 40 has moved to the specific location.

In a case where the UE 40 has moved to the specified location, the UE is registered. In addition, the UE 40 is connected and notifies the RAMNF 100 of arrival at the location. Note that the UE 40 can transition to the idle status after a certain period elapses after the notification.

Upon receiving the notification from the UE 40, the RAMNF 100 notifies the client 200 that the UE 40 has arrived at the designated location. The UE 40 is registered when arriving at the designated location. Therefore, the client 200 can acquire information such as the area information by accessing the UE 40 that has arrived at the designated location. For example, the client 200 can perform an operation such as causing the UE 40 to transmit the temperature of the designated location.

In a case where the UE 40 has moved out from the designated location, the UE transitions from the registered status to the de-registered status. The RAMNF 100 detects that the UE 40 has transitioned to the de-registered status, thereby being able to know that the UE 40 has moved out from the designated location. The RAMNF 100 may notify the client 200 that the UE 40 has left the designated location.

As described above, the RAMNF 100 according to the present embodiment collects the past terminal location information, the current terminal location information, and the future terminal location information. The cellular location information provided by the AMF 441 is current location information having low accuracy and including no past or future information. In this respect, the terminal location information according to the present embodiment is different from the cellular location information.

Furthermore, the RAMNF 100 combines the first information (for example, the registration information) regarding the network and the terminal location information and provides the combined information to the client 200. As a result, the client 200 can know the past or/and current location of the UE 40, and further can know whether or not the UE 40 is accessible. In addition, the client 200 can access a UE 40 that arrives at a specific location in the future. As a result, the client 200 can access the UE 40 at an appropriate time.

As described above, the RAMNF 100 can integrate the terminal-related information in the application layer level of the UE 40 and the information of the UE status acquired via the SBI API (an example of the first information) and provide the integrated information to the client 200.

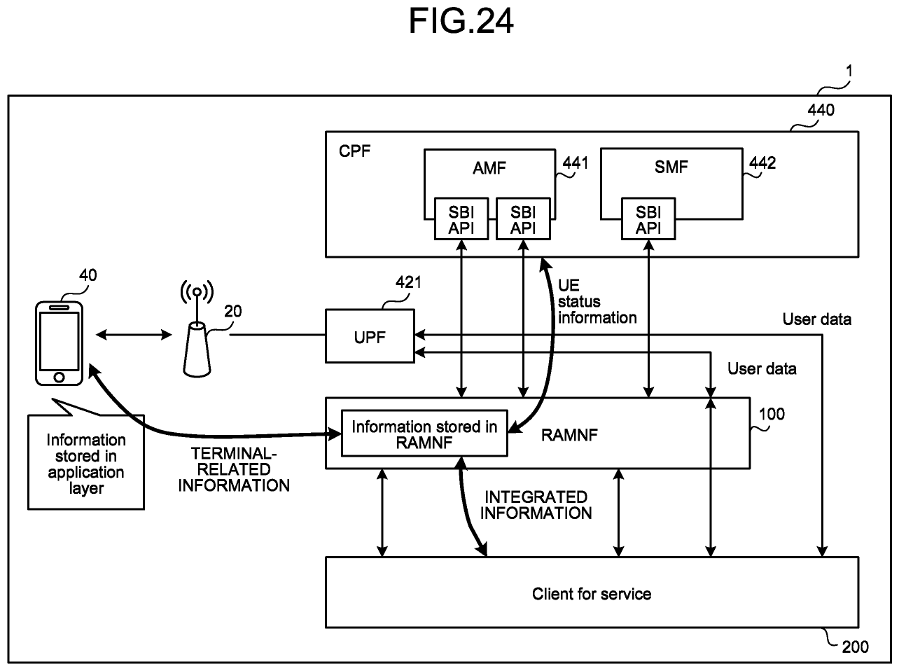

FIG. 24 is a diagram for describing an example of integration of information by the RAMNF 100 according to the second embodiment of the present disclosure.

The RAMNF 100 acquires the terminal-related information directly from the UE 40 or via the SBI. In addition, the RAMNF 100 acquires the UE status information from the CPF 440 of the core network CN via the SBI API. The RAMNF 100 notifies the client 200 of information obtained by integrating the terminal-related information and the UE status information.

By acquiring the terminal-related information and the UE status information, the RAMNF 100 can change a plan of the schedule of the UE status and the like based on, for example, the power information of the UE 40. In addition, the RAMNF 100 can optimize a time for accessing the UE 40 based on the terminal location information of the UE 40 and the UE status information by acquiring the terminal-related information and the UE status information.

As described above, the RAMNF 100 integrates (combines) information of different layers such as the information of the application layer of the UE 40 and the information regarding the network of the core network CN, and provides the integrated information to the client 200. As a result, the service and the network are combined, and the client 200 can provide a valuable new service.

### 4.4. Third Embodiment

### 4.4.1. Third Problem

As described above, the RAMNF 100 provides, to the client 200, the information of the network, for example, the UE status that is the network information of the UE 40. The UE status includes information indicating whether the UE 40 is registered or deregistered, and information indicating whether the UE is in the connected status or the idle status.

Here, in each of the embodiments described above, the client 200 makes an inquiry to the RAMNF 100 for each UE 40 and acquires the UE status of each UE 40.

For example, in a case where the number of UEs 40 targeted by the client 200 is large, the communication between the client 200 and the RAMNF 100 increases. In particular, in a case where the client 200 provides an IoT service, it is assumed that the number of UEs 40 that perform communication increases.

Furthermore, for example, in a case where the UE 40 targeted by the client 200 is not clearly determined, it is difficult for the client 200 to make an inquiry to the RAMNF 100. This is because an ID (for example, IMSI or SUPI) for specifying the UE 40 is used when the client 200 makes an inquiry to the RAMNF 100 in each of the embodiments described above. Note that the ID for specifying the UE 40 may be any information that can specify the UE 40, and is not limited to the IMSI or SUPI.

### 4.4.2. Example of Solution for Third Problem

Therefore, in the present embodiment, the RAMNF 100 notifies the client 200 of the group information (group based network information) including at least one piece of information regarding the UE 40 that satisfies a condition designated by the client 200.

The condition designated by the client 200 includes at least one of a registration condition that designates the registration status of the UE 40, a power condition that designates a power consumption status of the UE 40, and a location condition that designates the location of the UE 40.

### (Provision Processing According to Registration Condition)

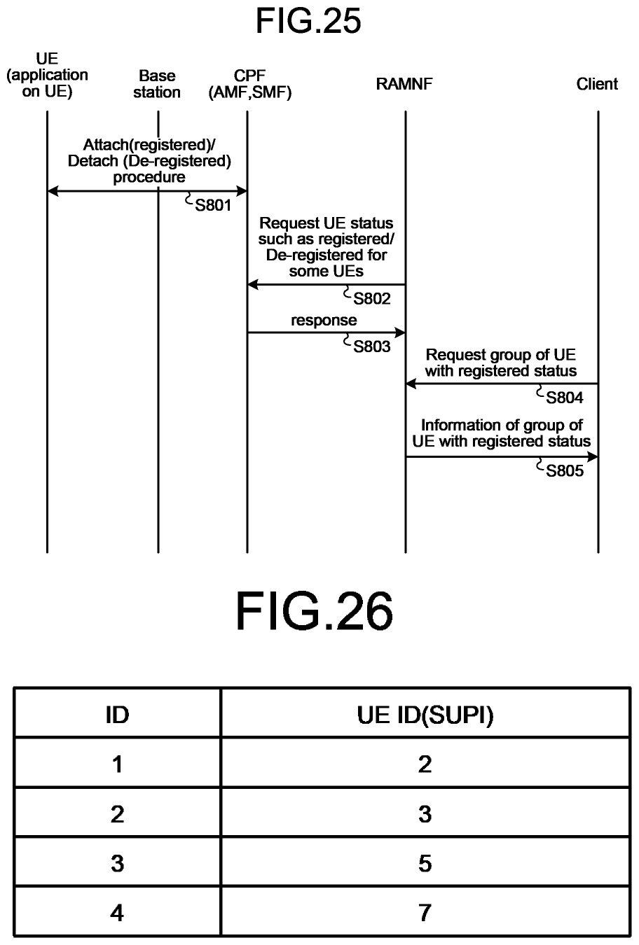

FIG. 25 is a sequence diagram illustrating an example of a flow of provision processing according to the registration condition according to the third embodiment of the present disclosure. Here, the RAMNF 100 acquires the group information of the UE 40 in the registered status in response to an instruction from the client 200. That is, here, it is assumed that the registration condition designated by the client 200 is the registered status.

As illustrated in FIG. 25, the UE 40 performs an attach (registered)/detach procedure with the CPF 440 (Step S801). Although the attach (registered)/detach (de-registered) procedure by one UE 40 is illustrated here, the CPF 440 can perform the attach (registered)/detach procedure with a plurality of UEs 40.

The RAMNF 100 inquires of the CPF 440 about the UE status such as the registered/de-registered status for some UEs 40 (Step S802), and obtains a response from the CPF 440 (Step S803).

The client 200 inquires of the RAMNF 100 about the group of the UE 40 in the registered status (Step S804).

The RAMNF 100 transmits, as a response to the client 200, the group information of the UE 40 in the registered status (Step S805).

Here, FIG. 26 is a table illustrating an example of the group information according to the third embodiment of the present disclosure. The group information illustrated in FIG. 26 is the group information of the UE 40 in the registered status.

As illustrated in FIG. 26, the group information includes an ID and a UE ID. The UE ID is, for example, an SUPI. Alternatively, the UE ID is not particularly limited as long as the UE ID is information specifying the UE 40 such as an IMSI.

The RAMNF 100 notifies the client 200 of information regarding at least one UE 40 in the registered status as the group information.

In this manner, the RAMNF 100 receives a request for the ID of the registered UE 40 from the client 200.

The RAMNF 100 notifies the client 200 of the UE ID of the registered UE 40 as the group information. The RAMNF 100 detects the group of the UE 40 corresponding to the registration condition (here, the UE 40 in the registered status) designated by the client 200 from all pieces of information that has been grasped and creates the group information.

Note that at least one RAMNF 100 can be arranged in one private network. The RAMNF 100 uses all the UEs 40 belonging to one private network as a population parameter, searches for the UE 40 corresponding to the condition from among them, and provides information to the client 200.

Note that the registration condition is not limited to whether the UE 40 is registered or de-registered. For example, the client 200 can request the RAMNF 100 for the group information by designating the idle status or the connected status as the registration condition.

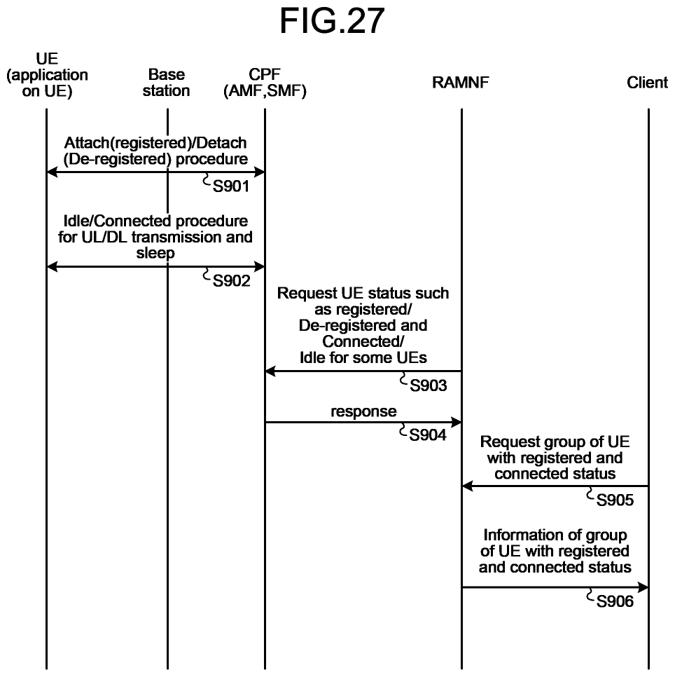

FIG. 27 is a sequence diagram illustrating another example of the flow of the provision processing according to the registration condition according to the third embodiment of the present disclosure. Here, the RAMNF 100 acquires the group information of the UE 40 in the registered status and the connected status in response to an instruction from the client 200. That is, here, it is assumed that the registration condition designated by the client 200 is the registered status and the connected status.

As illustrated in FIG. 27, the UE 40 performs an attach (registered)/detach procedure with the CPF 440 (Step S901). Although the attach (registered)/detach (de-registered) procedure by one UE 40 is illustrated here, the CPF 440 can perform the attach (registered)/detach procedure with a plurality of UEs 40.

The UE 40 performs the idle/connected procedure with the CPF 440 (Step S902). The idle/connected procedure is processing for the UE 40 to perform UL/DL communication or transition to a sleep status. Although the idle/connected procedure by one UE 40 is illustrated here, the CPF 440 can perform the idle/connected procedure with a plurality of UEs 40.

The RAMNF 100 inquires of the CPF 440 about the UE status such as the registered/de-registered status and the idle/connected status for some UEs 40 (Step S903), and obtains a response from the CPF 440 (Step S904).

The client 200 inquires of the RAMNF 100 about the group of the UE 40 that is in the registered status and in the connected status (Step S905).

The RAMNF 100 transmits, as a response to the client 200, the group information of the UE 40 in the registered status and the connected status (Step S906).

In this manner, the RAMNF 100 receives a request for the ID of the UE 40 that is in the registered status and the connected status from the client 200.

The RAMNF 100 notifies the client 200 of the UE ID of the UE 40 that is in the registered status and the connected status as the group information. The RAMNF 100 detects the group of the UE 40 corresponding to the registration condition (here, the UE 40 in the registered status and the connected status) designated by the client 200 from all pieces of information that has been grasped and creates the group information.

Note that at least one RAMNF 100 can be arranged in one private network. The RAMNF 100 uses all the UEs 40 belonging to one private network as a population parameter, searches for the UE 40 corresponding to the condition from among them, and provides information to the client 200.

Note that the registration condition is not limited to the UE 40 in the connected status. For example, the client 200 may request the RAMNF 100 for the group information by designating the UE 40 in the idle status.

### (Provision Processing According to Location Condition)

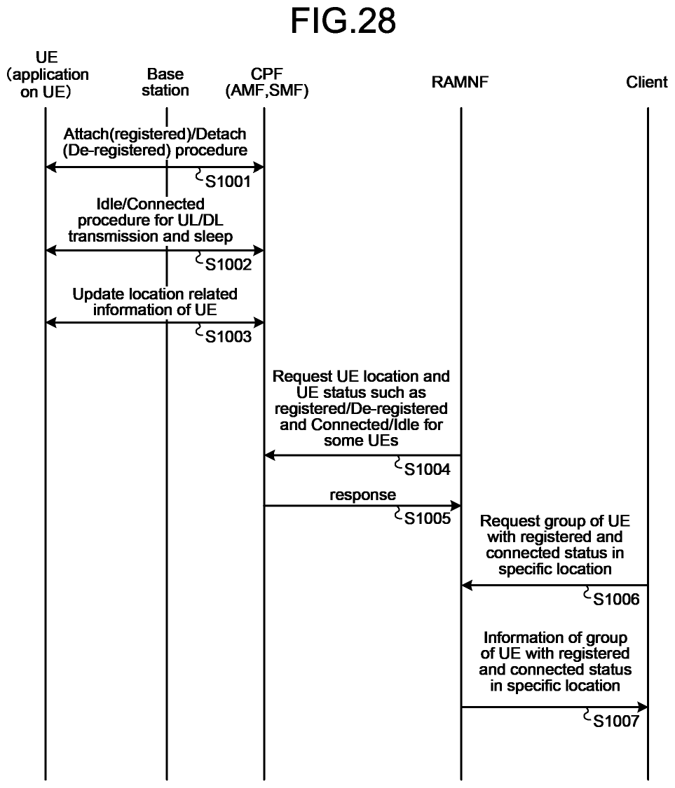

FIG. 28 is a sequence diagram illustrating an example of a flow of provision processing according to the location condition according to the third embodiment of the present disclosure. Here, the RAMNF 100 acquires the group information of the UE 40 in the registered status and the connected status in a designated area in response to an instruction from the client 200. That is, here, it is assumed that the registration condition designated by the client 200 is the registered status and the connected status, and the location condition is the current cellular location information.

As illustrated in FIG. 28, the UE 40 performs an attach (registered)/detach procedure with the CPF 440 (Step S1001). Although the attach (registered)/detach (de-registered) procedure by one UE 40 is illustrated here, the CPF 440 can perform the attach (registered)/detach procedure with a plurality of UEs 40.

The UE 40 performs the idle/connected procedure with the CPF 440 (Step S1002). The idle/connected procedure is processing for the UE 40 to perform UL/DL communication or transition to a sleep status. Although the idle/connected procedure by one UE 40 is illustrated here, the CPF 440 can perform the idle/connected procedure with a plurality of UEs 40.

The UE 40 updates information regarding the location of the UE 40 (for example, the cellular location information) for the CPF 440 (Step S1003). Although the update of the location information by one UE 40 is described here, the CPF 440 can update the location information with a plurality of UEs 40.

The RAMNF 100 inquires of the CPF 440 about the UE status such as the registered/de-registered status and the idle/connected status for some UEs 40 and the location information of the UE 40 (Step S1004). The RAMNF 100 obtains a response from the CPF 440 (Step S1005).

The client 200 inquires of the RAMNF 100 about the group of the UE 40 that is in the registered status and the connected status and is located in a specific location (Step S1006).

The RAMNF 100 transmits, as a response to the client 200, the group information of the UE 40 that is in the registered status and the connected status and is located in the specific location (Step S1007).

In this manner, the RAMNF 100 receives a request for the ID of the UE 40 that is in a specific area and is in the registered status and the connected status from the client 200.

The RAMNF 100 notifies the client 200 of the UE ID of the UE 40 that is in the specific area and is in the registered status and the connected status as the group information. The RAMNF 100 detects the group of the UE 40 corresponding to the registration condition (here, the UE 40 that is in the specific area and is in the registered status and the connected status) designated by the client 200 from all pieces of information that has been grasped and creates the group information.

Note that at least one RAMNF 100 can be arranged in one private network. The RAMNF 100 uses all the UEs 40 belonging to one private network as a population parameter, searches for the UE 40 corresponding to the condition from among them, and provides information to the client 200.

Note that the location condition is not limited to the condition that designates the cellular location information collected by the CPF 440. For example, the client 200 can request the RAMNF 100 for the group information by designating the terminal location information collected by the RAMNF 100 as the location condition.

Furthermore, the client 200 can request the RAMNF 100 for the group information by designating not only the current location information but also, for example, the past or future terminal location information as the location condition.

For example, the client 200 may register with the RAMNF 100 to be notified when a specific UE 40 enters a particular location. Further, in the present embodiment, the client 200 may register with the RAMNF 100 to be notified of information (for example, the UE ID) regarding the UE 40 that has entered a specific location on condition that the UE 40 has entered the specific location without specifying the UE 40.

### (Provision Processing According to Power Condition)

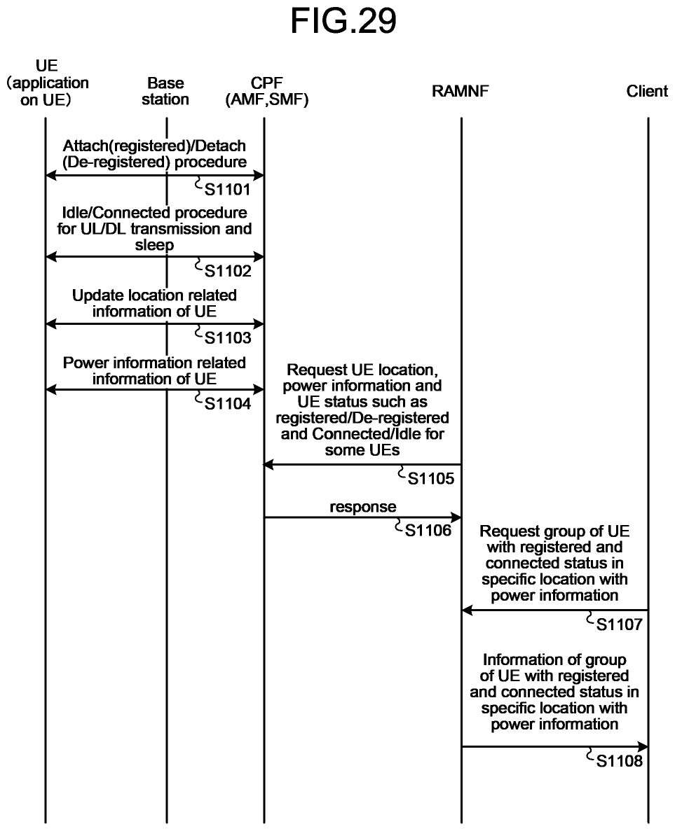

FIG. 29 is a sequence diagram illustrating an example of a flow of provision processing according to the power condition according to the third embodiment of the present disclosure. Here, the RAMNF 100 acquires the group information of the UE 40 that has a remaining battery level equal to or higher than a certain level and is in the registered status and the connected status in a designated area in response to an instruction from the client 200. That is, here, it is assumed that the registration condition designated by the client 200 is the registered status and the connected status. It is assumed that the location condition is the current cellular location information. It is assumed that the power condition is that the remaining battery level is equal to or higher than a certain level.

As illustrated in FIG. 29, the UE 40 performs an attach (registered)/detach procedure with the CPF 440 (Step S1101). Although the attach (registered)/detach (de-registered) procedure by one UE 40 is illustrated here, the CPF 440 can perform the attach (registered)/detach procedure with a plurality of UEs 40.

The UE 40 performs the idle/connected procedure with the CPF 440 (Step S1102). The idle/connected procedure is processing for the UE 40 to perform UL/DL communication or transition to a sleep status. Although the idle/connected procedure by one UE 40 is illustrated here, the CPF 440 can perform the idle/connected procedure with a plurality of UEs 40.

The UE 40 updates information regarding the location of the UE 40 (for example, the cellular location information) for the CPF 440 (Step S1103). Although the update of the location information by one UE 40 is described here, the CPF 440 can update the location information with a plurality of UEs 40.

The UE 40 notifies the CPF 440 of the information (for example, the power information) of the UE 40 regarding the power of the UE 40 (Step S1104). Although the notification of the power information by one UE 40 is illustrated here, the CPF 440 can receive a notification of the power information from a plurality of UEs 40.

The RAMNF 100 inquires of the CPF 440 about the UE status such as the registered/de-registered status and the idle/connected status for some UEs 40, the location information of the UE 40, and the power information (Step S1105). The RAMNF 100 obtains a response from the CPF 440 (Step S1106).

The client 200 inquires of the RAMNF 100 about the group of the UE 40 that is in the registered status and the connected status, is located in a specific location, and has predetermined power information (Step S1107). For example, the client 200 inquires of the RAMNF 100 about the group of the UE 40 that is in the registered status and the connected status, is located in a specific location, and has a remaining battery level that is equal to or higher than a certain value.

The RAMNF 100 transmits, as a response to the client 200, the group information of the UE 40 that is in the registered status and the connected status, is located in the specific location, and has predetermined power information (Step S1108). For example, the client 200 transmits, as a response to the RAMNF 100, the group information of the UE 40 that is in the registered status and the connected status, is located in a specific location, and has a remaining battery level that is equal to or higher than a certain value.

In this manner, the RAMNF 100 receives a request for the ID of the UE 40 that is in a specific power status (for example, the remaining battery level is equal to or higher than a certain level), is in a specific area, and is in the registered status and the connected status from the client 200.

The RAMNF 100 notifies the client 200 of the UE ID of the UE 40 that is in a specific power status, is in a specific area, and is in the registered status and the connected status as the group information. The RAMNF 100 detects the group of the UE 40 corresponding to the registration condition (here, the UE 40 that is in the specific area, is in the registered status and the connected status, and is in a specific power status) designated by the client 200 from all pieces of information that has been grasped and creates the group information.

Note that at least one RAMNF 100 can be arranged in one private network. The RAMNF 100 uses all the UEs 40 belonging to one private network as a population parameter, searches for the UE 40 corresponding to the condition from among them, and provides information to the client 200.

As described above, the RAMNF 100 according to the present embodiment provides, to the client 200, at least one UE 40 that satisfies the condition designated by the client 200 as the group information. As a result, the client 200 can receive one or more candidates for the UE 40 that satisfy the condition. The client 200 may access all the UEs 40 included in the group information, or may select and access a UE 40 from among them.

The client 200 can acquire information (for example, the registration information) regarding the status of the UE 40, which is one of the network information (first information), as the group. As a result, signaling between the client 200 and the RAMNF 100 is reduced according to the number of UEs 40 included in the group information as compared with a case where the UE 40 is designated to acquire the information.

As a result, the operation of the client 200 is simplified, and the client 200 can avoid a congested status of the network.

### 5. Application Example

Next, a case where the information processing system 1 according to an embodiment is applied will be described. Note that an application example of the information processing system 1 according to the third embodiment will be described below, but the first and second embodiments can be similarly applied to each case.

### 5.1. First Application Example

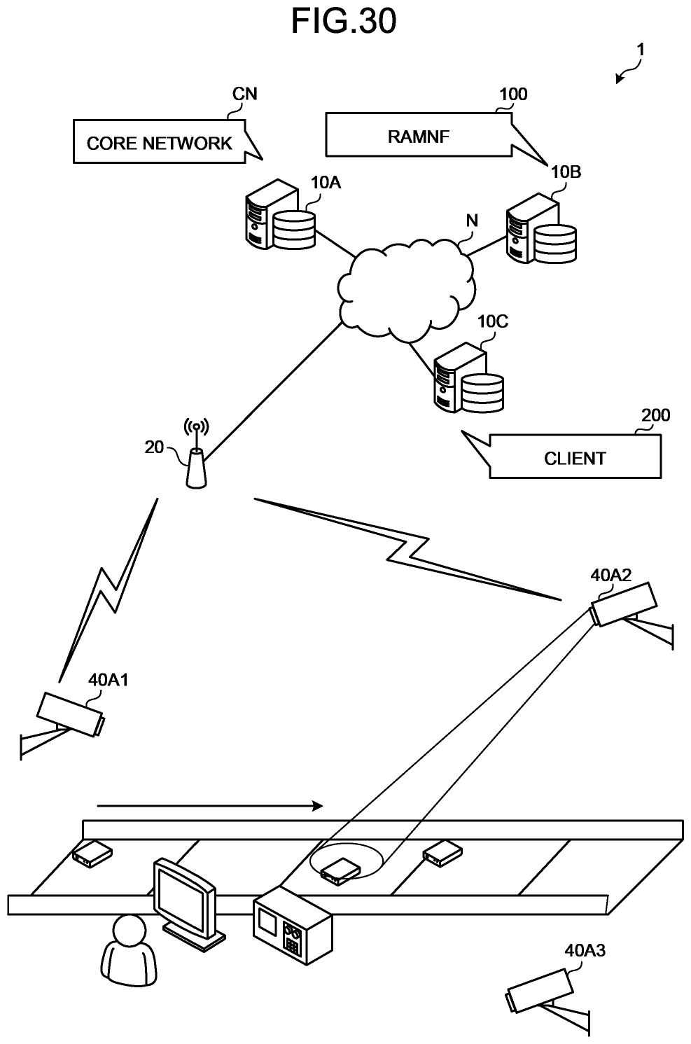

FIG. 30 is a diagram illustrating an example of the information processing system 1 according to a first application example of the present disclosure. FIG. 30 illustrates a case where the information processing system 1 is applied to a factory. Here, the UE 40 is a camera arranged in the factory.

FIG. 30 illustrates a case where three cameras 40A1 to 40A3 are arranged, but the number of cameras is not limited to three, and may be two or less, or four or more.

For example, the client 200 providing a management service for the factory makes an inquiry to the RAMNF 100 in order to know group information of the cameras that are arranged in a specific area in the factory (location condition) and are in the registered status (registration condition).

In the RAMNF 100, for example, it is assumed that the cameras 40A1 and 40A2 are the UEs 40 that satisfy the condition designated by the client 200. The RAMNF 100 responds to the client 200 with the group information including IDs (for example, the UE IDs) for specifying the cameras 40A1 and 40A2.

The client 200 that has received the group information accesses the camera 40A2, for example, and requests the camera 40A2 to upload information (alternatively, the currently captured image) captured by the camera 40A2.

As described above, the client 200 can acquire the group information regarding the UE 40 satisfying the condition from the RAMNF 100 by designating the condition.

### 5.2. Second Application Example

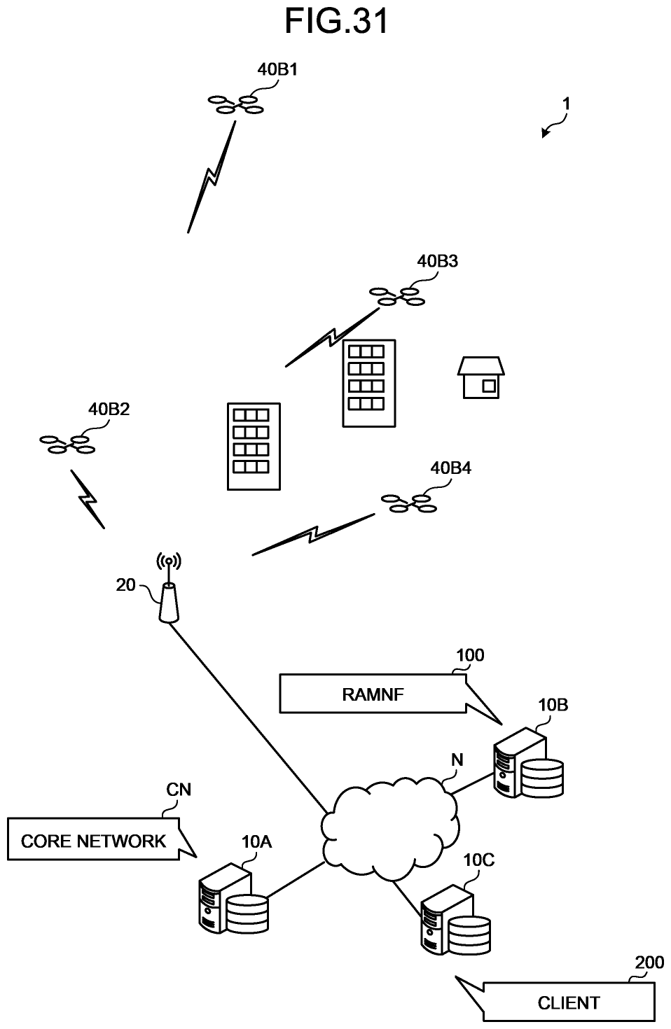

FIG. 31 is a diagram illustrating an example of the information processing system 1 according to a second application example of the present disclosure. FIG. 31 illustrates a case where the information processing system 1 is applied to a drone system. Here, the UE 40 is a drone.

FIG. 31 illustrates a case where four drones 40B1 to 40B4 are flying, but the number of drones is not limited to four, and may be three or less or five or more. For example, the number of drones may be several hundred.

For example, the client 200 providing a management service for the drones makes an inquiry to the RAMNF 100 in order to know group information of the drones that have passed through a specific area and performed image capturing. At this time, in order to immediately access the drone, the client 200 designates a drone that is currently in the registered status and makes an inquiry about the group information. That is, the client 200 makes an inquiry to the RAMNF 100 by using the past terminal location information (having passed through the specific area in the past) as the location condition and using the current registered status as the registration condition.

In the RAMNF 100, for example, it is assumed that the drones 40B2 and 40B4 are the UEs 40 that satisfy the conditions designated by the client 200. The RAMNF 100 responds to the client 200 with the group information including IDs (for example, the UE IDs) for specifying the drones 40B2 and 40B4.

The client 200 that has received the group information accesses the drone 40B2, for example, and requests the drone 40B2 to upload information captured by the drone 40B2 in the specific area.

As described above, the client 200 can acquire the group information regarding the UE 40 satisfying the condition from the RAMNF 100 by designating the condition. At this time, the client 200 can designate the past terminal location information and acquire the group information.

### 5.3. Third Application Example

A case where the information processing system 1 is applied to a temperature measurement system will be described. Here, the UE 40 is a temperature sensor arranged in a region. A large number of temperature sensors may be arranged in the region. In addition, there may be a plurality of regions in which the temperature sensors are arranged. A battery of such a temperature sensor is often difficult to be replaced, and it is thus desired to suppress power consumption as much as possible.

Therefore, the client 200 that manages the temperature sensor makes an inquiry to the RAMNF 100 in order to know group information of the temperature sensors in the RRC connected status. At this time, the client 200 may designate a region and make an inquiry.

The RAMNF 100 responds to the client 200 with the group information including IDs (for example, the UE IDs) for specifying the temperature sensors that satisfy the condition (being in the RRC connected status).

The client 200 that has received the group information selects, for example, a predetermined number (for example, five) of temperature sensors among the temperature sensors included in the group information in such a way that the positions of the temperature sensors are distributed. The client 200 accesses the selected temperature sensors and acquires temperature information.

As a result, the client 200 can access a temperature sensor in the RRC connected status, and does not need to activate the temperature sensors in the RRC idle status. In addition, the client 200 can access a temperature sensor at a desired location among the temperature sensors in the RRC connected status, and can acquire desired temperature information.

### 6. Other Embodiments

The above-described embodiments and application examples show only examples, and various modifications and applications are possible.

For example, a control device that controls the information processing device 10, the base station 20, and the terminal device 40 of the above-described embodiments may be implemented by a dedicated computer system or may be implemented by a general-purpose computer system.

For example, a communication program for performing the above-described operations is stored in a computer-readable recording medium such as an optical disk, a semiconductor memory, a magnetic tape, or a flexible disk, and distributed. Then, for example, the control device is implemented by installing the program in a computer and performing the above-described processing. At this time, the control device may be a device (for example, a personal computer) outside the information processing device 10, the base station 20, and the terminal device 40. Furthermore, the control device may be a device (for example, the control units 13, 24, and 45) inside the information processing device 10, the terminal device 40, and the base station 20.

Further, the communication program may be stored in a disk device included in a server device on a network such as the Internet, and be downloaded to a computer. Further, the functions described above may be implemented by cooperation between an operating system (OS) and application software. In this case, the part other than the OS may be stored in a medium and distributed, or the part other than the OS may be stored in a server device and downloaded to a computer.

Further, among the respective processing described in the above-described embodiments, all or some of the processing described as being automatically performed can be manually performed. Alternatively, all or some of the processing described as being manually performed can be automatically performed by a known method. In addition, the processing procedures, specific names, information including various data and parameters illustrated in the specification and drawings can be arbitrarily changed unless otherwise specified. For example, various pieces of information illustrated in the drawings are not limited to those illustrated in the drawings.

Further, each illustrated component of each device is functionally conceptual, and does not necessarily have to be configured physically as illustrated in the drawings. That is, the specific modes of distribution/integration of the respective devices are not limited to those illustrated in the drawings. All or some of the devices can be functionally or physically distributed/integrated in any arbitrary unit, depending on various loads or the usage status. Note that this configuration by distribution and integration may be dynamically made.

Further, the above-described embodiments can be appropriately combined as long as the processing contents do not contradict each other. Further, the order of the steps illustrated in the sequence diagram of the above-described embodiments can be changed as appropriate.

Furthermore, for example, the present embodiment can be implemented as any component included in the device or system, for example, a processor as a system large scale integration (LSI) or the like, a module using a plurality of processors or the like, a unit using a plurality of modules or the like, a set obtained by further adding other functions to a unit, or the like (that is, some components of the device).

Note that, in the present embodiment, the system means a set of a plurality of components (devices, modules (parts), and the like), and it does not matter whether or not all the components are in the same housing. Therefore, a plurality of devices housed in separate housings and connected via a network and one device in which a plurality of modules are housed in one housing are both systems.

Furthermore, for example, the present embodiment can adopt a configuration of cloud computing in which one function is shared and processed by a plurality of devices in cooperation via a network.

### 7. Conclusion

Although the embodiments of the present disclosure have been described above, the technical scope of the present disclosure is not limited to the above-described embodiments, and various modifications can be made without departing from the scope of the present disclosure. Moreover, components of different embodiments and modified examples may be appropriately combined.

Further, the effects in each embodiment described in the present specification are merely examples. The effects of the present disclosure are not limited thereto, and other effects may be obtained.

Note that the present technology can also have the following configurations.

(1)

An information processing device comprising:
a control unit that
acquires first information regarding a terminal device from a core network via a service based interface (SBI),
acquires second information including at least one of measurement information measured based on the first information or terminal-related information acquired from the terminal device directly or via the SBI,
specifies the terminal device from the second information or by associating the first information and the second information with each other, and
notifies a client device of at least one of the first information or the second information in association with the specified terminal device.

(2)

The information processing device according to (1), wherein the terminal-related information includes information included in an application layer of the terminal device.

(3)

The information processing device according to (1) or (2), wherein the terminal-related information includes at least one of schedule information regarding a registration schedule, power information regarding power consumption of the terminal device, or location information regarding a location of the terminal device.

(4)

The information processing device according to (3), wherein the location information is measured using equipment mounted on the terminal device.

(5)

The information processing device according to (3) or (4), wherein
the location information includes at least one of current location information, past location information, or future location information.

(6)

The information processing device according to any one of (3) to (5), wherein
the first information includes registration information regarding registration of the terminal device, and
the client device determines the terminal device to access based on the power information and the registration information.

(7)

The information processing device according to any one of (3) to (6), wherein
the first information includes registration information regarding registration of the terminal device, and
the client device determines the terminal device to access based on the location information and the registration information.

(8)

The information processing device according to any one of (1) to (7), wherein the control unit notifies the client device of group information including at least one piece of information regarding the terminal device that satisfies a condition designated by the client device.

(9)

The information processing device according to (8), wherein the condition includes at least one of a registration condition that designates a registration status of the terminal device, a power condition that designates a power consumption status of the terminal device, or a location condition that designates a location of the terminal device.

(10)

The information processing device according to (9), wherein the location condition includes a condition that designates at least one of a current location, a past location, or a future location of the terminal device.

(11)

The information processing device according to any one of (1) to (10), wherein
the first information includes registration information regarding registration of the terminal device, and
the measurement information includes information regarding a transition interval of registration of the terminal device calculated based on the registration information.

(12)

The information processing device according to (11), wherein the measurement information includes information regarding an idle transition time until the terminal device transitions to an idle status.

(13)

The information processing device according to (12), wherein the client device communicates with the terminal device before a timing at which the terminal device transitions to the idle status based on the measurement information.

(14)

An information processing method comprising:
acquiring first information regarding a terminal device from a core network via a service based interface (SBI);
acquiring second information including at least one of measurement information measured based on the first information or terminal-related information acquired from the terminal device directly or via the SBI;
specifying the terminal device from the second information or by associating the first information and the second information with each other; and
notifying a client device of at least one of the first information or the second information in association with the specified terminal device.

(15)

A terminal device comprising:
a control unit that notifies an information processing device of terminal-related information directly or via a service based interface (SBI), wherein
the information processing device
acquires first information regarding the terminal device from a core network via the SBI,
specifies the terminal device from the terminal-related information or by associating the first information and the terminal-related information with each other, and
notifies a client device of at least one of the first information or the terminal-related information in association with the specified terminal device

(16)

A system comprising: a first information processing device; a second information processing device that functions as a network function of a core network; and a terminal device, wherein
the first information processing device comprises a control unit that
acquires first information regarding the terminal device from the second information processing device via a service based interface (SBI),
acquires second information including at least one of measurement information measured based on the first information or terminal-related information acquired from the terminal device directly or via the SBI,
specifies the terminal device from the second information or by associating the first information and the second information with each other, and
notifies a client device of at least one of the first information or the second information in association with the specified terminal device.

### REFERENCE SIGNS LIST

1 Information processing system
10 Information processing device
11 Communication unit
12, 22, 42 Storage unit
13, 24, 45 Control unit
20 Base station
21, 41 Signal processing unit
23 Network communication unit
40 Terminal device
44 Input/output unit

1. An information processing device, comprising:
one or more network interfaces; and
circuitry configured to:
acquire, using the one or more network interfaces, first information regarding a terminal device from a core network via a service based interface (SBI),
acquire, using the one or more network interfaces, second information including terminal-related information acquired from the terminal device directly or via the SBI, the terminal-related information being application layer information of the terminal device,
specify the terminal device from the second information or by associating the first information and the second information with each other, and
notify a client device of the first information and the second information in association with the specified terminal device.

2. The information processing device according to claim 1, wherein the terminal-related information is behavior information of the terminal device that originates from the application layer of the terminal device.

3. The information processing device according to claim 1, wherein the terminal-related information includes at least one of schedule information regarding a registration schedule, power information regarding power consumption of the terminal device, or location information regarding a location of the terminal device.

4. The information processing device according to claim 3, wherein the location information is measured using equipment mounted on the terminal device.

5. The information processing device according to claim 3, wherein
the location information includes at least one of current location information, past location information, or future location information.

6. The information processing device according to claim 3, wherein
the first information includes registration information regarding registration of the terminal device, and
the terminal device is accessed by the client device based on the power information and the registration information.

7. The information processing device according to claim 3, wherein
the first information includes registration information regarding registration of the terminal device, and
the terminal device is accessed by the client device based on the location information and the registration information.

8. The information processing device according to claim 1, wherein the circuitry is further configured to
notify the client device of group information including at least one piece of information regarding the terminal device that satisfies a condition designated by the client device.

9. The information processing device according to claim 8, wherein the condition includes at least one of a registration condition that designates a registration status of the terminal device, a power condition that designates a power consumption status of the terminal device, or a location condition that designates a location of the terminal device.

10. The information processing device according to claim 9, wherein the location condition includes a condition that designates at least one of a current location, a past location, or a future location of the terminal device.

11. The information processing device according to claim 1, wherein
the first information includes registration information regarding registration of the terminal device, and
the measurement information includes information regarding a transition interval of registration of the terminal device calculated based on the registration information.

12. The information processing device according to claim 11, wherein the measurement information includes information regarding an idle transition time until the terminal device transitions to an idle status.

13. The information processing device according to claim 12, wherein the terminal device receives communication from the client device before a timing at which the terminal device transitions to the idle status based on the measurement information.

14. An information processing method, comprising:
acquiring, using one or more network interfaces, first information regarding a terminal device from a core network via a service based interface (SBI);
acquiring, using the one or more network interfaces, second information including terminal-related information acquired from the terminal device directly or via the SBI, the terminal-related information being application layer information of the terminal device;
specifying the terminal device from the second information or by associating the first information and the second information with each other; and
notifying a client device of the first information and the second information in association with the specified terminal device.

15. A terminal device, comprising:
circuitry configured to
notify a core network of first information via a service based interface (SBI), and
notify an information processing device of second information including terminal-related information directly or via the SBI, the terminal-related information being application layer information of the terminal device.

16. A system, comprising:
a first information processing device;
a second information processing device that functions as a network function of a core network; and
a terminal device, wherein
the first information processing device includes one or more network interfaces and circuitry configured to
acquire, using the one or more network interfaces, first information regarding the terminal device from the second information processing device via a service based interface (SBI),
acquire, using the one or more network interfaces, second information including terminal-related information acquired from the terminal device directly or via the SBI, the terminal-related information being application layer information of the terminal device,
specify the terminal device from the second information or by associating the first information and the second information with each other, and
notify a client device of the first information and the second information in association with the specified terminal device.
